(19) United States
(12) Patent Application Publication
(10) Pub. No.: US 2013/0029718 A1
(43) Pub. Date: Jan. 31, 2013

(54) MOBILE COMMUNICATION APPARATUS AND WIRELESS COMMUNICATION METHOD

(71) Applicant: Naritoshi SAITO, Kawasaki (JP)

(72) Inventor: Naritoshi SAITO, Kawasaki (JP)

(73) Assignee: FUJITSU TOSHIBA MOBILE COMMUNICATIONS LIMITED, Kawasaki-shi (JP)

(21) Appl. No.: 13/555,280

(22) Filed: Jul. 23, 2012

(30) Foreign Application Priority Data
Jul. 28, 2011 (JP) 2011-165222

(51) Int. Cl. H04W 36/14

(52) U.S. Cl. 455/525

(57) ABSTRACT

In a mobile communication apparatus capable of performing data communication by use of a first wireless access network and a second wireless access network, a receiver processes signals received from the first wireless access network and the second wireless access network, and a controller includes a processor, and establishes a connection to the second wireless access network and stops processing of signals received from the first wireless access network when the processor transitions to a suspend state after data communication using the first wireless access network is performed.

### CROSS-REFERENCE TO RELATED APPLICATION

This application is based on and claims the benefits of priority of the prior Japanese Patent Application No. 2011-165222, filed on Jul. 28, 2011, the entire contents of which are incorporated herein by reference.

### FIELD

The embodiments discussed herein relate to a mobile communication apparatus and a wireless communication method.

### BACKGROUND

Currently, wireless communication systems such as mobile telephone systems and wireless LANs (Local Area Network) are being widely used. The wireless access networks which mobile communication apparatuses can use include various types of wireless access networks (e.g., the CDMA2000 1x network, the CDMA2000 EVDO network, and the WiMAX network) respectively using different communication protocols. (The CDMA stands for Code Division Multiple Access, EVDO stands for Evolution Data Only, and WiMAX stands for Worldwide Interoperability for Microwave Access.) The CDMA2000 1x network and the CDMA2000 EVDO network use the CDMA (Code Division Multiple Access) as a multiple access technology, and the WiMAX network uses the OFDMA (Orthogonal Frequency Division Multiple Access) as a multiple access technology. Some types of mobile communication apparatuses can use more than one type of wireless access networks.

For example, a previously proposed wireless communication device which can use a mobile telephone system and a wireless LAN inquires of the user whether to inactivate the functions realizing a mobile telephone for reducing the power consumption in the coverage area of the wireless LAN when the wireless communication device detects movement into the coverage area of the wireless LAN. In addition, a previously proposed terminal which can use a wide-area wireless network and a small-area wireless network starts processing for establishing a connection to the wide-area wireless network when the terminal detects that the signal quality becomes equal to or lower than a reference value during use of the small-area wireless network. (See, for example, Japanese Laid-open Patent Publications Nos. 2005-295532 and 2008-118721.)

However, some mobile communication apparatuses use a processor for controlling data communication and user interface. In some cases, the processor transitions to a suspend state (in which the power consumption is low) when no event (for example, none of data communication, manipulation by a user, and the like) occurs during a certain period of time. In the suspend state, the processor suspends execution of an application program and/or a driver program and waits for occurrence of an event. When the processor detects occurrence of an event, the processor returns to an active state.

When the processor transitions to a suspend state, a receiver unit, which processes signals received from a wireless access network, continues signal processing for, for example, wireless synchronization and a search for a base station according to an instruction given by the processor before the transition to the suspend state. At this time, in some cases where the mobile communication apparatuses can use two or more wireless access networks for data communication, continuing of signal processing for two or more different wireless access networks becomes disadvantageous in power consumption. For example, in the case where signal processing for a wireless access network covering a small area, in addition to signal processing for a wireless access network covering a wide area, is continued, the frequency of searches for a base station and the power consumption can be increased by movement of a mobile communication apparatus.

Further, when data is to be transmitted from a network to the mobile communication apparatus, the mobile communication apparatus receives paging for data communication. In the case where the mobile communication apparatus can use two or more wireless access networks, paging information is transmitted by using one of the two or more wireless access networks in which a data communication path is established. After data communication is performed by using the one of the wireless access networks, the data communication path remains established in the one of the wireless access networks. Therefore, after signal processing for one of the wireless access networks is stopped, sometimes the mobile communication apparatus cannot receive paging even when the mobile communication apparatus is in the coverage area of the other of the wireless access networks.

### SUMMARY

According to one aspect, there is provided a mobile communication apparatus which is capable of performing data communication by use of a first wireless access network and a second wireless access network. The mobile communication apparatus includes: a receiver which processes signals received from the first wireless access network and the second wireless access network; and a controller which includes a processor, and establishes a connection to the second wireless access network and stops processing of signals received from the first wireless access network when the processor transitions to a suspend state after data communication using the first wireless access network is performed.

The objects and advantages of the invention will be realized and attained by means of the elements and combinations particularly pointed out in the claims.

It is to be understood that both the forgoing general description and the following detailed description are exemplary and explanatory and are not restrictive of the invention.

### BRIEF DESCRIPTION OF DRAWINGS

FIG. 1 illustrates a mobile communication apparatus according to a first embodiment;

FIG. 2 illustrates a mobile communication system according to a second embodiment;

FIG. 3 illustrates examples of coverage areas of wireless access networks;

FIG. 4 illustrates examples of wireless channels in wireless access networks;

FIG. 5 illustrates examples of physical channels in another wireless access network;

FIGS. 6A, 6B, and 6C illustrate examples of reception timings of paging channels;

FIG. 7 illustrates an example of an out-of-service search;

FIG. 8 illustrates an example of a hardware construction of a mobile station;

FIG. 9 is a block diagram illustrating the mobile station for wireless transmission and reception;

FIG. 10 illustrates functions of software executed by a control unit in the mobile station;

FIG. 11 illustrates examples of transitions between data communication states;

FIG. 12 illustrates an example of a screen for selecting off setting in a suspend state;

FIG. 13 illustrates an example of a flow of operations performed by a CPU when the CPU transitions to the suspend state;

FIG. 14 illustrates an example of a flow of operations performed by the CPU when the CPU is released from the suspend state;

FIG. 15 illustrates examples of transitions between data communication states related to suspension;

FIGS. 16 and 17 illustrate an example of a sequence of operations performed for establishing a connection to a wireless access network;

FIG. 18 illustrates an example of a sequence of operations performed for reception of a paging channel;

FIG. 19 illustrates an example of a sequence of operations performed for establishing a connection to another wireless access network;

FIG. 20 illustrates an example of a sequence of operations performed for establishing a PPP connection;

FIG. 21 illustrates an example of a sequence of operations performed for reception of another paging channel; and

FIGS. 22 and 23 illustrate an example of a sequence of operations performed for handover.

### DESCRIPTION OF EMBODIMENTS

The embodiments will be explained below with reference to the accompanying drawings, wherein like reference numbers refer to like elements throughout.

### 1. First Embodiment

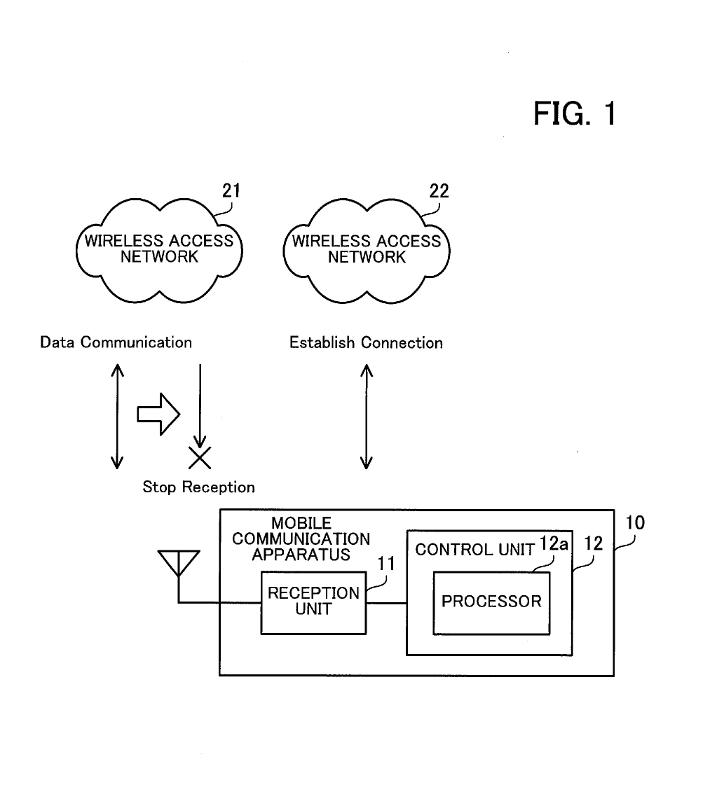

FIG. 1 illustrates the mobile communication apparatus according to the first embodiment.

The mobile communication apparatus 10 performs data communication (e.g., packet communication) by using wireless access networks 21 and 22. The mobile communication apparatus 10 can operate in dual or multiple modes. The mobile communication apparatus 10 is, for example, a wireless terminal such as a mobile telephone (including the so-called smartphone) or a personal digital assistant.

Each of the wireless access networks 21 and 22 contains a base station for transmitting wireless signals. The wireless access networks 21 and 22 may use different wireless communication protocols, respectively. The wireless access network 21 may be, for example, a wireless access network using CDMA such as the CDMA2000 EVDO network or the W-CDMA (Wideband Code Division Multiple Access) network, and the wireless access network 22 may be, for example, a wireless access network using OFDMA such as the WiMAX network, the LTE (Long Term Evolution) network, or the LTE-A (Long Term Evolution Advanced) network. The extent of the coverage area of each of the wireless access networks 21 and 22 may be different. For example, the extent of the coverage area of the wireless access network 21 may be smaller than the extent of the coverage area of the wireless access network 22.

The mobile communication apparatus 10 contains a reception unit 11 and a control unit 12.

The reception unit 11 processes signals received from the wireless access networks 21 and 22. The processing of the received signals includes processing for, for example, timing synchronization, searching for a base station, and detection of a paging channel (as a wireless channel). Paging information for data communication addressed to the mobile communication apparatus 10 is transmitted through the paging channel.

The control unit 12 controls data communication using the wireless access networks 21 and 22, and contains a processor 12a. The processor 12a is a processing device such as a CPU (Central Processing Unit) which executes a program. The control unit 12 may further contain a memory such as a RAM (Random Access Memory).

When no event (for example, none of data communication, the user's operations, and the like) occurs during a certain period of time, the processor 12a transitions to a suspend state (in which power consumption is low). In the suspend state, the processor 12a suspends execution of application program and driver program and waits for occurrence of an event. When the processor 12a detects occurrence of an event, the processor 12a returns to an active state. When an event occurs, for example, an interrupt signal is inputted into the processor 12. On receipt of the interrupt signal, the processor 12a transitions from the suspend state to an active state. The interrupt signal is transmitted through a GPIO (General Purpose Input/Output) interface.

When the processor 12a transitions to the suspend state after data communication by using the wireless access network 21, the control unit 12 establishes a connection to the wireless access network 22. The connection may be a PPP (Point-to-point Protocol) connection. Thus, the data communication path is switched from the wireless access network 21 to the wireless access network 22. In addition, the control unit 12 stops processing, performed in the reception unit 11, of the signals received from the wireless access network 21, and continues processing of the signals received from the wireless access network 22. The connection to the wireless access network 22 may be established either before or after the suspension of the signals received from the wireless access network 21. The establishment of the connection to the wireless access network 22 and the suspension of the signals received from the wireless access network 21 are controlled, for example, by using the processor 12a before the processor 12a transitions to the suspend state.

When the processor 12a is released from the suspend state, the control unit 12 may make the reception unit 11 restart the processing of the signals received from the wireless access network 21, and make the reception unit 11 perform handover from the wireless access network 22 to the wireless access network 21. Thus, the data communication path returns from the wireless access network 22 to the wireless access network 21. The handover is controlled, for example, by using the processor 12a after the release from the suspend state. The handover may be performed in such a manner that an address (e.g., an IP (Internet Protocol) address) allocated to the mobile communication apparatus 10 is not changed by the handover.

The mobile communication apparatus 10 may contain a storage device (e.g., a nonvolatile storage device such as a flash memory) for storing setting information. The mobile communication apparatus 10 may be configured to allow the user to correct the setting information by using user interfaces (e.g., an input device such as a touchscreen and an output device such as a display device) with which the mobile communication apparatus 10 is provided. The setting information includes, for example, information indicating whether or not the processing of the signals received from the wireless access network 21 is continued while the processor 12a is in the suspend state. In this case, the control unit 12 may determine the processing which is performed when the processor 12a transitions to the suspend state, by reference to the setting information stored in the storage device.

In the mobile communication apparatus 10 according to the first embodiment, the signals received from the wireless access networks 21 and 22 are processed. Before the processor 12a transitions to the suspend state after data communication is performed in the wireless access network 21, a connection to the wireless access network 22 is established, and the processing of the signals received from the wireless access network 21 is stopped. Thereafter, the processor 12a transitions to the suspend state. Therefore, while the processor 12a is in the suspend state, the processing of the signals received from the wireless access network 21 can be stopped, so that the power consumption can be reduced compared with the case where both of the processing of the signals received from the wireless access network 21 and the processing of the signals received from the wireless access network 22 are continued. In particular, in the case where the coverage area of the wireless access network 21 is smaller than the coverage area of the wireless access network 22, increase in power consumption caused by frequently occurring searches for a base station in the wireless access network 21 can be avoided by stopping the processing of the signals received from the wireless access network 21.

In addition, the data communication path established in the wireless access network 21 can be switched to a data communication path in the wireless access network 22 by establishing a connection in the wireless access network 22. Therefore, while the processor 12a is in the suspend state, the mobile communication apparatus 10 can receive paging addressed to the mobile communication apparatus 10 for data communication even when the processing of the signals received from the wireless access network 21 is stopped. The data communication path to each of the wireless access networks 21 and 22 may be exclusively established.

### 2. Second Embodiment

The second embodiment is explained below. In the second embodiment, data communication performed by using the CDMA2000 EVDO network and the WiMAX network is taken as an example. However, the communication control method according to the second embodiment cam be applied to data communication using other wireless access networks such as the W-CDMA network, the LTE network, and the LTE-A network.

### 2.1 Mobile Communication System

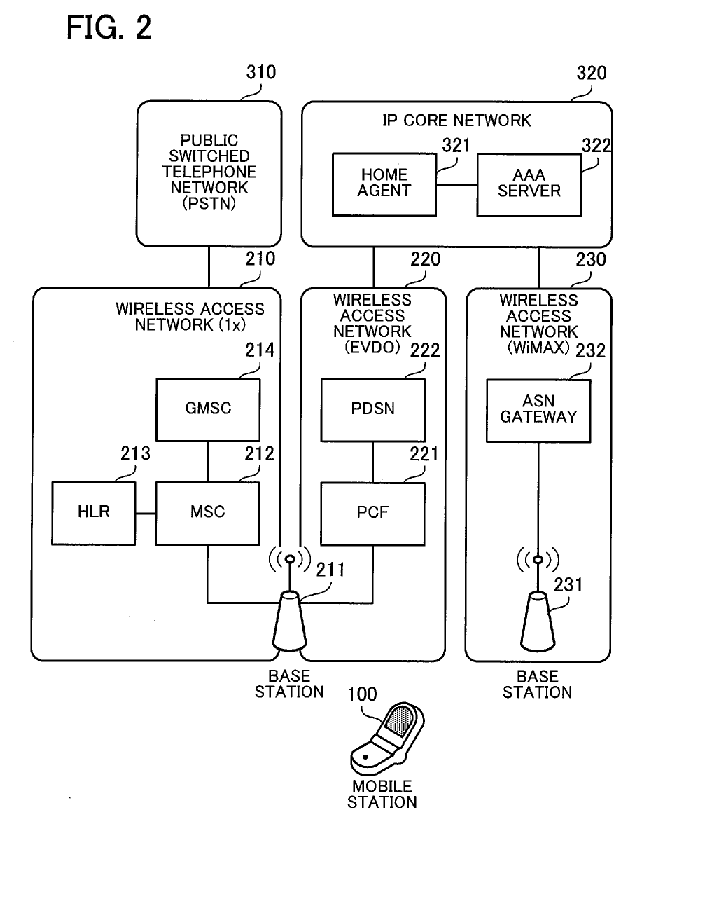

FIG. 2 illustrates a mobile communication system according to the second embodiment. The mobile communication system of FIG. 2 contains a mobile station 100, wireless access networks 210, 220, and 230, a public switched telephone network (PSTN) 310, and an IP core network 320.

The mobile station 100 is a wireless terminal such as a mobile telephone or a personal digital assistant. The mobile station 100 can perform wireless communication in accordance with the three communication protocols of CDMA2000 1x, CDMA2000 EVDO, and WiMAX. Specifically, the mobile station 100 performs voice communication in accordance with the CDMA2000 1x protocol, and performs data communication in accordance with the CDMA2000 EVDO or WiMAX protocol.

The wireless access network 210 provides to the mobile station 100 a wireless communication service in accordance with the CDMA2000 lx protocol. Voice signals are transmitted in the wireless access network 210 in a circuit switched manner. The wireless access network 210 is connected to the PSTN 310. The wireless access network 210 contains a plurality of base stations including a base station 211, a mobile switching center (MSC) 212, a home location register (HLR) 213, and a gateway mobile switching center (GMSC) 214. Each of the base stations realizes a cell, and the coverage area of the wireless access network 210 is constituted by a set of the cells.

The base station 211 is a communication apparatus which performs wireless communication with the mobile station 100, and performs wired communication with the MSC 212. The base station 211 transfers voice signals between the mobile station 100 and the MSC 212. The MSC 212 is a switching device connected to the base station 211 and the GMSC 214. The MSC 212 establishes a connection to the mobile station 100 through the base station 211, and processes voice signals. The HLR 213 manages a database of subscriber information. The subscriber information is to be referred to by the MSC 212 for use in control of voice communication. The GMSC 214 is a gateway connected to the PSTN 310, and transfers the voice signals.

The wireless access network 220 provides to the mobile station 100 a wireless communication service in accordance with the CDMA2000 EVDO protocol, and data is transmitted in the wireless access network 220 in a packet-switched manner. The wireless access network 220 is connected to the IP core network 320. The wireless access network 220 contains a plurality of base stations (which are used in common with the wireless access network 210), a packet control function (PCF) 221, and a packet data serving node (PDSN) 222. Each of the base stations realizes a cell, and the coverage area of the wireless access network 220 is constituted by a set of the cells. Although the base station 211 belongs to both of the wireless access network 210 and the wireless access network 220 in the example of FIG. 2, alternatively, the base station 211 may be divided into a base station belonging to the wireless access network 210 and a base station belonging to the wireless access network 220.

The base station 211 performs wireless communication with the mobile station 100, and wired communication with the PCF 221. The base station 211 transfers packetized data between the mobile station 100 and the PCF 221. The PCF 221 is connected to the base station 211 and the PDSN 222, and transfers the packetized data. The PDSN 222 is a gateway connected to the IP core network 320. The PDSN 222 establishes a PPP connection to the mobile station 100 through the base station 211 and the PCF 221, and transfers the packetized data.

The wireless access network 230 provides to the mobile station 100 a wireless communication service in accordance with the WiMAX protocol, and data is transmitted in the wireless access network 230 in a packet-switched manner. The wireless access network 230 is connected to the IP core network 320. The wireless access network 230 contains a plurality of base stations including the base station 231 and an ASN (Access Service Network) gateway 232. Each of the base stations realizes a cell, and the coverage area of the wireless access network 230 is constituted by a set of the cells.

The base station 231 is a communication apparatus which performs wireless communication with the mobile station 100, and performs wired communication with the ASN gateway 232. The base station 231 transfers packetized data between the mobile station 100 and the ASN gateway 232. The ASN gateway 232 is a gateway connected to the IP core network 320, and transfers the packetized data.

The PSTN 310 is a telephone network in which voice signals are transmitted in a circuit-switched manner, and contains one or more switching devices. The PSTN 310 can also be used in communication performed by fixed phones. Further, it is possible to use an ISDN (Integrated Service Digital Network) instead of the PSTN 310.

The IP core network 320 is an IP network which controls data communication with the mobile station 100. The IP core network 320 is connected to the wireless access networks 220 and 230, and contains a home agent (HA) 321 and an AAA (Authentication, Authorization, and Accounting) server 322.

The HA 321 is a communication device which registers the mobile station 100, and transfers data to and from the mobile station 100 on the basis of the registered information, when the mobile station 100 is connected to the wireless access networks 220 and 230. The HA 321 confirms which of the wireless access networks 220 and 230 the mobile station 100 is currently using for performing data communication, and transfers data addressed to the mobile station 100, to the PDSN 222 or the ASN gateway 232. The AAA server 322 is a server which performs authentication of the mobile station 100 and bills the user of the mobile station 100.

The mobile station 100 selects one of the wireless access networks 220 and 230, and performs data communication. The data communication path is established by exclusively using the one of the wireless access networks 220 and 230. When the mobile station 100 establishes a PPP connection to the wireless access network 220, the mobile station 100 and the IP core network 320 recognize the state in which a data communication path is established by using the wireless access network 220 and not using the wireless access network 230. On the other hand, when the mobile station 100 is connected to the wireless access network 230 (by performing an entry procedure), the mobile station 100 and the IP core network 320 recognize that the data communication path between the mobile station 100 and the IP core network 320 is switched from the wireless access network 220 to the wireless access network 230, and the PPP connection using the wireless access network 220 becomes ineffective.

When data to be transmitted from the IP core network 320 to the mobile station 100 occurs while the mobile station 100 is not performing data communication, paging information is transmitted to the mobile station 100 from one of the wireless access networks 220 and 230 in which a data communication path is established. When a PPP connection to the wireless access network 220 is established, the base station 211 wirelessly transmits the paging information to the mobile station 100. On the other hand, when the mobile station 100 is connected to the wireless access network 230, no PPP connection is established by using the wireless access network 220, and the base station 231 wirelessly transmits the paging information to the mobile station 100.

The mobile station 100 is an example of the mobile communication apparatus 10 in the first embodiment, the wireless access network 230 is an example of the wireless access network 21 in the first embodiment, and the wireless access network 220 is an example of the wireless access network 22 in the first embodiment.

### 2.2 Coverage Areas

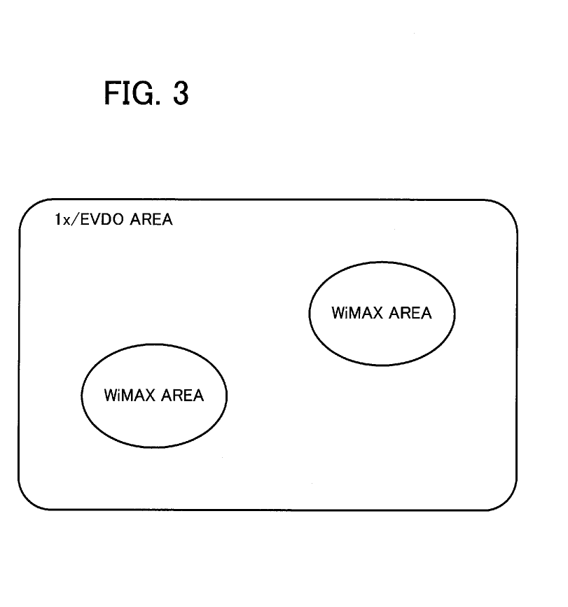

FIG. 3 illustrates examples of coverage areas of wireless access networks. In the second embodiment, the coverage area of the wireless access network 230 (using WiMAX) is smaller than the coverage area of each of the wireless access networks 210 and 220 (respectively using CDMA2000 1x and EVDO), and overlaps at least one a part of the coverage areas of the wireless access networks 210 and 220. For example, the coverage area of the wireless access network 230 may include separated areas which are located in the coverage areas of the wireless access networks 210 and 220. Since the coverage area of the wireless access network 230 is relatively small, the mobile station 100 can easily move out of the coverage area of the wireless access network 230. However, when the mobile station 100 uses the wireless access network 230, the mobile station 100 can perform data communication at higher speed with a broader band than the wireless access network 220. Therefore, it is preferable that the mobile station 100 preferentially uses the wireless access network 230 when the mobile station 100 performs data communication in the coverage area of the wireless access network 230.

### 2.3 Wireless Channels

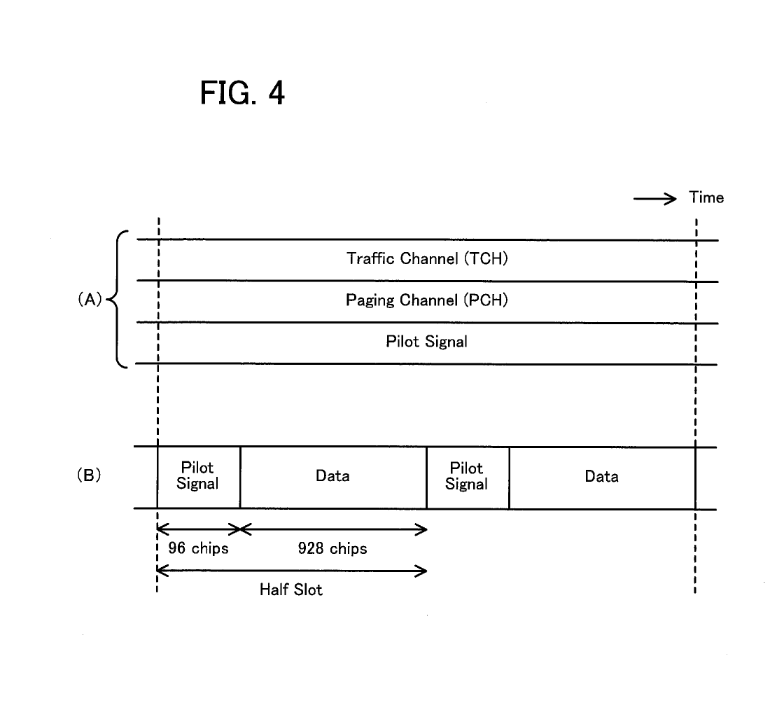

FIG. 4 roughly illustrates examples of wireless channels in the wireless access networks 210 and 220. In FIG. 4, an example of a set of wireless channels in accordance with the CDMA2000 1x protocol used in the wireless access network 210 is indicated by the reference (A), and an example of a set of wireless channels in accordance with the CDMA2000 EVDO protocol used in the wireless access network 220 is indicated by the reference (B).

In the wireless access network 210, the base station 211 transmits, at different frequencies, a traffic channel (TCH), a paging channel (PCH), and a known pilot channel (pilot signal). The traffic channel may transmit a voice signal, and the paging signal may contain paging information indicating that a voice signal is incoming. While the mobile station 100 is in a standby state, the mobile station 100 intermittently confirms the existence or absence of the paging information addressed to the mobile station 100, and determines whether or not a voice signal is incoming. In addition, the mobile station 100 receives the pilot signal, and achieves timing synchronization with the pilot signal.

In the wireless access network 220, the base station 211 transmits data together with a known pilot signal in a time sharing manner at an identical frequency. In every half slot constituted by 1024 chips, 928 chips are allocated to data and 96 chips are allocated to the pilot signal. The data includes paging information indicating that data is incoming. The mobile station 100 intermittently confirms the existence or absence of the paging information addressed to the mobile station 100, and determines whether or not data is incoming. In addition, the mobile station 100 receives the pilot signal, and achieves timing synchronization with the pilot signal.

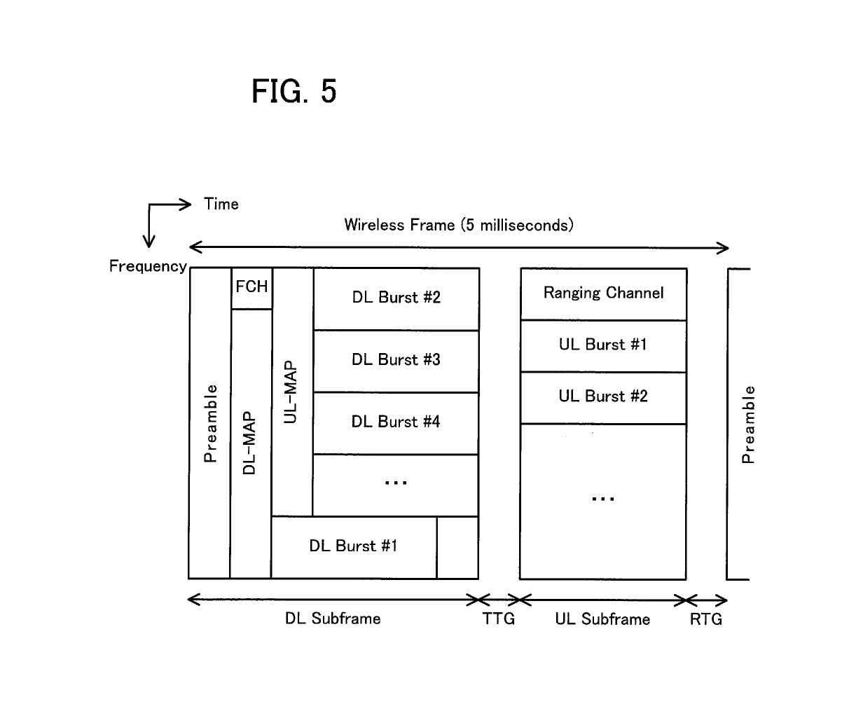

In addition, examples of physical channels in the wireless access network 230 are explained below. FIG. 5 illustrates an example of an OFDMA wireless frame used in the wireless access network 230 (using the WiMAX protocol).

According to OFDMA, wireless resources, which are finely divided in both of the frequency direction and the time direction, are allocated to various wireless channels. The wireless frame having the length of five milliseconds contains a downlink (DL) subframe and an uplink (UL) subframe. In addition, a gap called TTG (Transmit Transition Gap) is inserted after the DL subframe before the UL following subframe in each wireless frame, and a gap called RTG (Receive Transition Gap) is inserted after each UL subframe before the following DL subframe in the next wireless frame.

The DL subframe transmitted from the base station 231 contains a preamble, an FCH (Frame Control Header), a DL-MAP (downlink map), a UL-MAP (uplink map), and UL bursts, and the UL subframe transmitted from the mobile station 100 contains a ranging channel and UL bursts.

The preamble is a known pilot signal, the FCH (Frame Control Header) contains information for the mobile station 100 recognizing the positions of the DL-MAP, and the DL-MAP is control information indicating allocation of the wireless resources to the DL bursts, where the UL-MAP is also deemed as a UL burst in the control information. The DL bursts may contain packetized data, paging information, a UCD (Uplink Channel Descriptor), and other information. The UCD indicates the property of the uplink channels, for example, the modulation and coding schemes which can be used in the UL bursts.

The mobile station 100 can transmit to the base station 231 a ranging code (which is a predetermined bit series) through the ranging channel. The base station 231 recognizes the existence of the mobile station 100 accessing the base station 231, by detecting the ranging code. The mobile station 100 can transmit packetized data to the base station 231 as the UL bursts. When the mobile station 100 is connected to the wireless access network 230, the mobile station 100 receives the preamble and achieves synchronization. Then, the mobile station 100 transmits the ranging code to the base station 231 through the ranging channel. In addition, while the mobile station 100 is in a standby state, the mobile station 100 intermittently confirms the existence or absence of the paging information addressed to the mobile station 100, and determines whether or not data is incoming.

### 2.4 Timings of Paging Channels

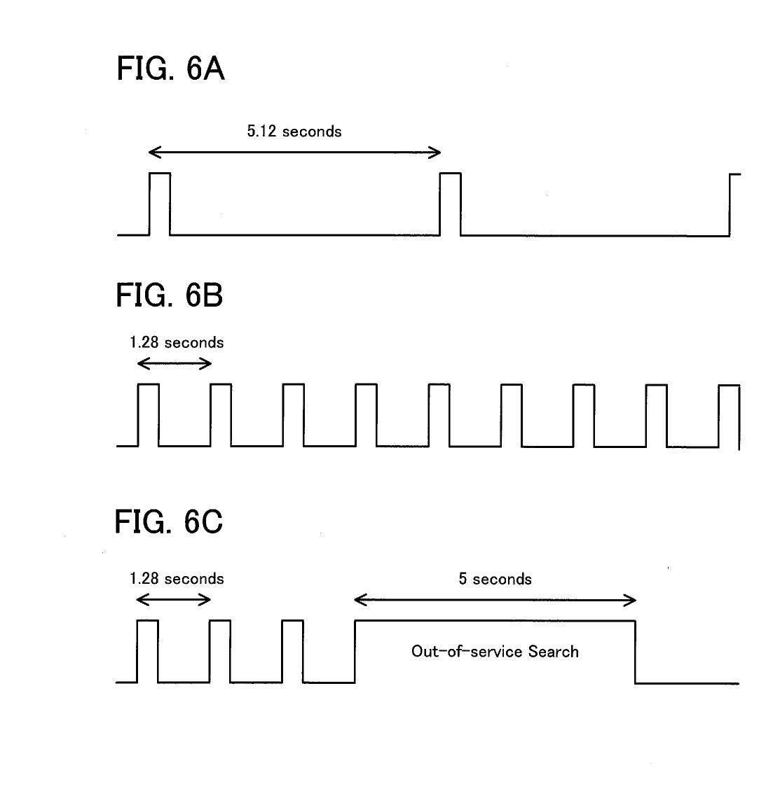

FIGS. 6A, 6B, and 6C illustrate examples of reception timings of the paging channels.

While a PPP connection between the mobile station 100 and the wireless access network 220 is established, and the mobile station 100 is waiting in an idle mode for CDMA2000 EVDO communication, the mobile station 100 intermittently receives the paging channel from the base station 211. In addition, while the mobile station 100 is connected to the wireless access network 230, and the mobile station 100 is waiting in an idle mode for WiMAX communication, the mobile station 100 intermittently receives the paging channel from the base station 231.

For example, while the mobile station 100 is waiting in the idle mode for CDMA2000 EVDO communication, the mobile station 100 receives the paging channel from the base station 211 every 5.12 seconds as illustrated in FIG. 6A. At this time, a data communication path is established in the wireless access network 220, and no paging information is transmitted from the wireless access network 230 to the mobile station 100. Therefore, the mobile station 100 needs not to receive the paging channel from the base station 231 for WiMAX communication.

In addition, for example, while the mobile station 100 is waiting in the idle mode for WiMAX communication, the mobile station 100 receives the paging channel from the base station 231 every 1.28 seconds as illustrated in FIG. 6B. At this time, a data communication path is established in the wireless access network 230, and no paging information is transmitted from the wireless access network 220 to the mobile station 100. Therefore, the mobile station 100 needs not to receive the paging channel from the base station 211 for CDMA2000 EVDO communication.

When the mobile station 100 fails in reception from the paging channel for WiMAX communication during the waiting (standby) state for WiMAX communication, for example, the mobile station 100 makes a search (out-of-service search) for an accessible base station for at most five seconds as illustrated in FIG. 6C. When the mobile station 100 does not detect an accessible base station in five seconds, the mobile station 100 determines that the mobile station 100 moves out of the coverage area of the wireless access network 230. Thereafter, the mobile station 100 may intermittently makes a search (out-of-service search) in order to detect return to the coverage area of the wireless access network 230.

### 2.5 Out-of-service Search

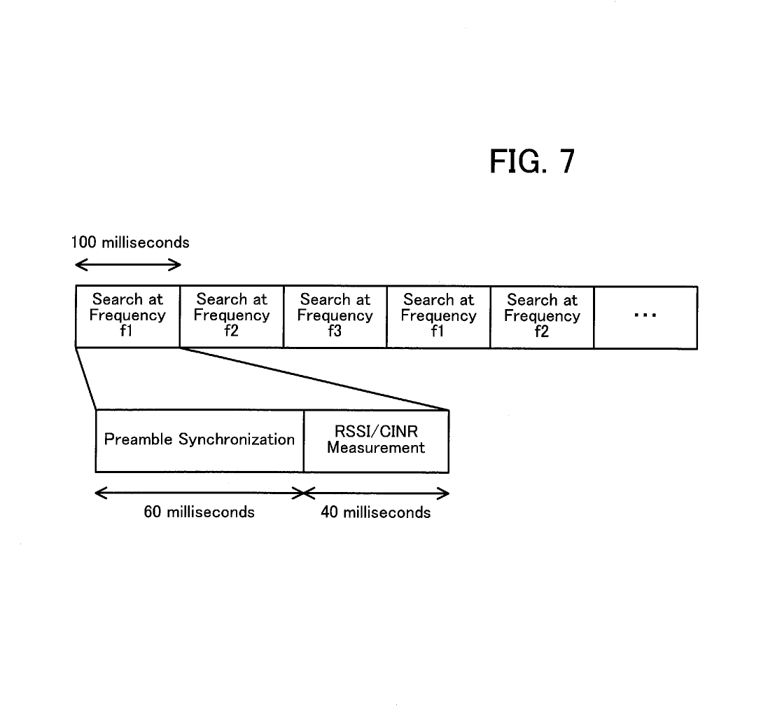

FIG. 7 illustrates an example of an out-of-service search. In the example of FIG. 7, it is assumed that the cells in the wireless access network 230 use one of three frequency bands for wireless communication, where the center frequencies f1, f2, and f3 of the three frequency bands are, for example, 2.62 GHz, 2.61 GHz, and 2.60 GHz, respectively. In the out-of-service search, the mobile station 100 repeatedly searches for the three frequencies f1, f2, and f3 by switching, every 100 milliseconds, the frequency searched for. Each search for the 100 milliseconds contains first processing for sixty seconds and second processing for forty seconds. In the first processing, the mobile station 100 makes an attempt to achieve timing synchronization by detecting the preamble, and narrows the preamble indexes down from 114 to ten. In the second processing, the mobile station 100 measures the RSSI (Received Signal Strength Indication) indicating the received signal level and the CINR (Carrier to Interference and Noise Ratio) indicating the reception quality. In addition, the mobile station 100 determines the used preamble index. For example, the mobile station 100 determines that the cells having the RSSI and the CINR not falling below respective thresholds are to be accessible from the mobile station 100.

### 2.6 Hardware of Mobile Station

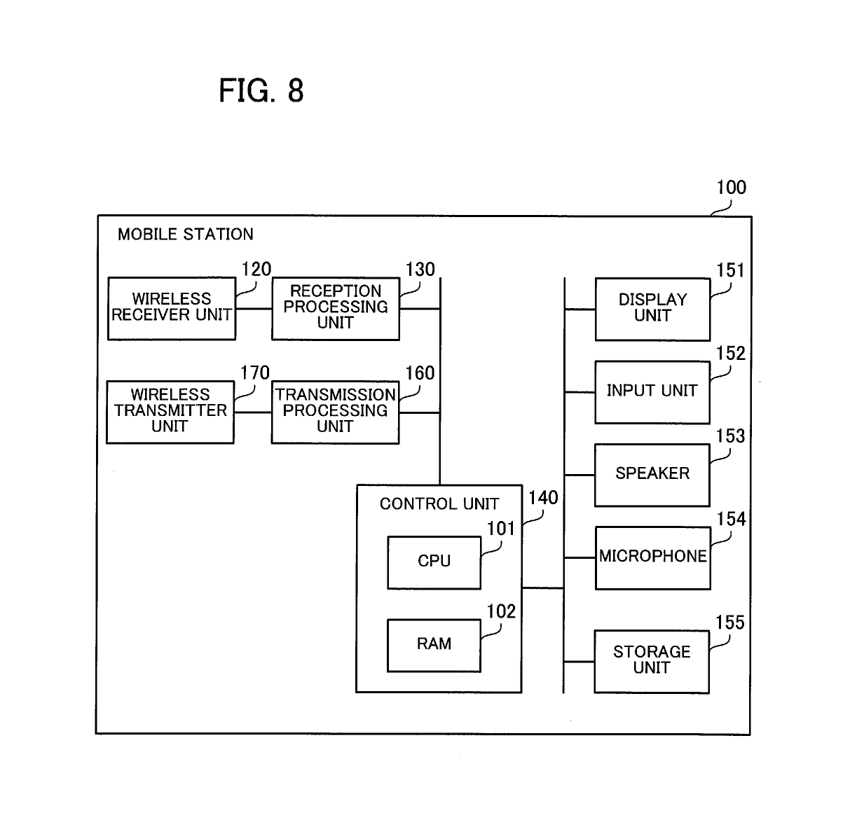

FIG. 8 illustrates an example of a hardware construction of the mobile station 100. The mobile station 100 contains a wireless receiver unit 120, a reception processing unit 130, a control unit 140, a display unit 151, an input unit 152, a speaker 153, a microphone 154, a storage unit 155, a transmission processing unit 160, and a wireless transmitter unit 170. The control unit 140 contains a CPU 101 and a RAM 102.

The wireless receiver unit 120 processes wireless signals received from the wireless access networks 210, 220, and 230. The wireless receiver unit 120 converts (downconverts) the wireless signals (having radio frequencies) to digital baseband signals, and outputs the digital baseband signals to the reception processing unit 130.

The reception processing unit 130 acquires from the wireless receiver unit 120 the digital baseband signals as received signals, and performs baseband processing including digital demodulation and error-correction decoding. The reception processing unit 130 extracts voice signals or data from the received signals, and outputs the extracted voice signals or data to the control unit 140.

The control unit 140 controls wireless communications using the wireless receiver unit 120, the reception processing unit 130, the transmission processing unit 160, and the wireless transmitter unit 170. In addition, the control unit 140 controls the user interface realized by use of the display unit 151, the input unit 152, the speaker 153, and the microphone 154.

The CPU 101 is a processor which executes programs including application programs and driver programs. The driver programs include a wireless communication program for controlling the reception processing unit 130 and the transmission processing unit 160 and a user interface program for controlling the display unit 151 and the input unit 152. The CPU 101 reads at least portions of data and programs stored in the storage unit 155, and executes the programs. The RAM 102 is a volatile memory which temporarily stores programs and data for use by the CPU 101.

When no event occurs during a predetermined time while the CPU 101 is in an active state, the CPU 101 transitions to a suspend state (in which power consumption is low). When an event occurs while the CPU 101 is in the suspend state, the CPU 101 returns to the active state. In the active state, the CPU 101 executes one or more of the application programs and the driver programs. In the suspend state, the CPU 101 terminates the program execution, and waits for input of an interrupt signal indicating occurrence of an event. The event includes data communication and a manipulation by the user. Each interrupt signal is inputted into the CPU 101 through a GPIO signal line. For example, an interrupt signal indicating data communication is inputted into the CPU 101 from the reception processing unit 130, and an interrupt signal indicating a manipulation by the user is inputted into the CPU 101 from the input unit 152.

The display unit 151 is an interface which acquires an image frame from the control unit 140, and displays an image. For example, the display unit 151 may be realized by a liquid-crystal display (LCD) device or an organic electroluminescence (OEL) display device.

The input unit 152 is an interface which receives input by the user, and outputs an input signal to the control unit 140. For example, the input unit 152 may be realized by a touchscreen or a keypad. In the case where a touchscreen is used, the touchscreen is arranged on the display unit 151, and detects the position at which the user touches the screen. The user may touch the screen with the user's finger or a pointing device such as a stylus. The position at which the user touches the screen may be detected in a manner using, for example, a matrix switch, a resistive film, a surface acoustic wave, infrared light, electromagnetic induction, or electrostatic capacity. In the case where the keypad is used, one or more input keys are arranged on the outer side of the housing of the mobile station 100.

The speaker 153 is an interface which converts an electric signal (as a voice signal) into physical vibration for reproducing sound. For example, the speaker 153 outputs the voice of the opposite party and background noise during a telephone conversation by the user. The microphone 154 is an interface which receives voice input by converting acoustic vibration into an electric signal as a voice signal, and outputs the electric signal to the control unit 140. For example, the voice of the user and background noise are inputted through the microphone 154 during a telephone conversation by the user.

The storage unit 155 is a nonvolatile memory which stores programs and data. The storage unit 155 may be realized by a flash memory. The programs stored in the storage unit 155 include one or more application programs and driver programs corresponding to the interfaces provided in the mobile station 100, and the data stored in the storage unit 155 include setting information. As explained later, the setting information includes information indicating whether or not the mobile station 100 should continue signal processing for the wireless access network 230 (in accordance with the WiMAX protocol) while the CPU 101 is in the suspend state. The setting information is inputted by the user by using the display unit 151 and the input unit 152, and written in the storage unit 155 by the control unit 140.

The transmission processing unit 160 acquires from the control unit 140 voice signals and data which are generated by the mobile station 100, and performs baseband processing including digital modulation and error-correction encoding, and generates digital baseband signals. Then, the transmission processing unit 160 outputs to the wireless transmitter unit 170 the digital baseband signals as signals to be transmitted to the wireless access networks 210, 220, and 230. The wireless transmitter unit 170 processes the signals to be transmitted. Specifically, the wireless transmitter unit 170 converts (upconverts) the digital baseband signals acquired from the transmission processing unit 160, to wireless signals (having radio frequencies), and outputs the wireless signals through antennas.

For example, the reception processing unit 130 and the transmission processing unit 160 are connected to the control unit 140 through a first bus. In addition, the display unit 151, the input unit 152, the speaker 153, the microphone 154, and the storage unit 155 are connected to the control unit 140 through a second bus. The first and second buses may be realized by a single bus, or different buses as illustrated in FIG. 8.

The wireless receiver unit 120 and the reception processing unit 130 constitute an example of the reception unit 11 in the first embodiment. In addition, the control unit 140 and the CPU 101 are respectively examples of the control unit 12 and the processor 12a in the first embodiment.

### 2.7 Functions of Mobile Station

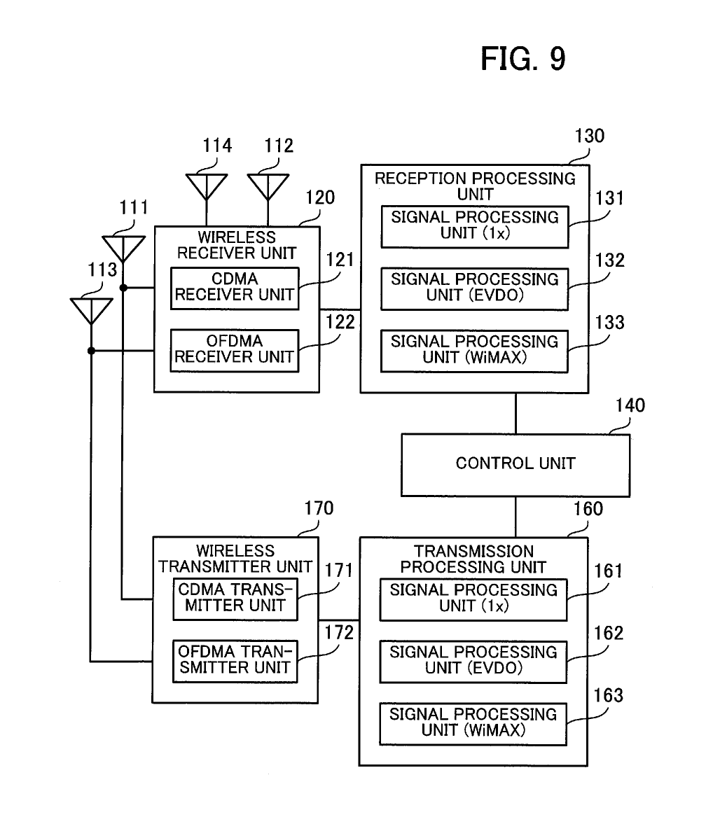

FIG. 9 is a block diagram illustrating the mobile station for wireless transmission and reception. As illustrated in FIG. 9, the mobile station 100 further has the antennas 111,112, 113, and 114 in addition to the elements illustrated in FIG. 8. The antennas 111 and 113 are for use in both of transmission and reception, and the antennas 112 and 114 are used in reception. Wireless signals from the wireless access networks 210 and 220 are received through the antennas 111 and 112, and wireless signals from the mobile station 100 are transmitted through the antenna 111 to the wireless access networks 210 and 220. In addition, wireless signals from the wireless access network 230 are received through the antennas 113 and 114, and wireless signals from the mobile station 100 are transmitted through the antenna 113 to the wireless access network 230.

The wireless receiver unit 120 contains a CDMA receiver unit 121 and an OFDMA receiver unit 122. The CDMA receiver unit 121 processes the wireless signals received through the antennas 111 and 112 in accordance with the CDMA2000 1x or EVDO protocol. Further, the communication through the antennas 111 and 112 may be performed by using the diversity or MIMO (Multiple Input Multiple Output) technique. The OFDMA receiver unit 122 processes the wireless signals received through the antennas 113 and 114 in accordance with the WiMAX protocol. Further, the communication through the antennas 113 and 114 may also be performed by using the diversity or MIMO (Multiple Input Multiple Output) technique.

The reception processing unit 130 contains signal processing units 131, 132, and 133. The signal processing unit 131 acquires the digital baseband signals from the CDMA receiver unit 121, and extracts voice signals by performing baseband processing in accordance with the CDMA2000 1x protocol. The signal processing unitl32 acquires the digital baseband signals from the CDMA receiver unit 121, and extracts packetized data by performing baseband processing in accordance with the CDMA2000 EVDO protocol. The baseband processing performed by the signal processing units 131 and 132 includes spread-spectrum demodulation (despreading). The signal processing unit 133 acquires the digital baseband signals from the OFDMA receiver unit 122, and extracts packetized data by performing baseband processing in accordance with the WiMAX protocol. The baseband processing performed by the signal processing unit 133 includes fast Fourier transform (FFT).

The transmission processing unit 160 contains signal processing units 161, 162, and 163. The signal processing unit 161 acquires voice signals from the control unit 140, and performs baseband processing in accordance with the CDMA2000 1x protocol. The signal processing unit 162 acquires data from the control unit 140, and performs baseband processing in accordance with the CDMA2000 EVDO protocol. The baseband processing performed by the signal processing units 161 and 162 includes spread-spectrum modulation (spreading). The signal processing unit 163 acquires data from the control unit 140, and performs baseband processing in accordance with the WiMAX protocol. The baseband processing performed by the signal processing unit 163 includes inverse fast Fourier transform (IFFT).

The wireless transmitter unit 170 contains a CDMA transmitter unit 171 and an OFDMA transmitter unit 172. The CDMA transmitter unit 171 processes the digital baseband signals acquired from the signal processing unit 161 in accordance with the CDMA2000 1x protocol or the digital baseband signals acquired from the signal processing unit 162 in accordance with the CDMA2000 EVDO protocol so as to generate wireless signals to be transmitted, and outputs the wireless signals to the antenna 111. The OFDMA transmitter unit 172 processes the digital baseband signals acquired from the signal processing unit 163 in accordance with the WiMAX protocol so as to generate wireless signals to be transmitted, and outputs the wireless signals to the antenna 113.

While the mobile station 100 is in the standby state (in which the mobile station 100 performs neither of voice communication and data communication), the signal processing unit 131 intermittently operates to perform position registration in the wireless access network 210 (using CDMA2000 1x) and receive the paging channel. In addition, while the mobile station 100 is in the standby state, the signal processing unit 132 intermittently operates to perform position registration in the wireless access network 220 (using CDMA2000 EVDO) and receive the paging channel when the PPP connection is effective. When the PPP connection is not effective, the 132 needs not to receive the paging channel. Further, while the mobile station 100 is in the standby state, the signal processing unit 133 intermittently operates to perform position registration in the wireless access network 230 (using WiMAX) and receive the paging channel when the connection to the wireless access network 230 is effective. When the connection to the wireless access network 230 is not effective, the signal processing unit 133 needs not to receive the paging channel. Furthermore, the signal processing units 131, 132, and 133 make a search for a base station when necessary.

While the mobile station 100 is in the standby state, the signal processing units 131, 132, and 133 can stop the signal processing except when the above intermittent operations are performed (for example, except when the signal processing units 131, 132, and 133 receive the paging channels). The timings at which the signal processing units 131, 132, and 133 are to receive the paging channels are informed by the base stations 211 and 231, for example, before the mobile station 100 transitions to the standby state. While the CPU 101 is in the suspend state, the signal processing units 131, 132, and 133 intermittently perform signal processing on the basis of instructions from the control unit 140. When each of the signal processing units 131, 132, and 133 detects paging information addressed to the mobile station 100 while the CPU 101 is in the suspend state, or when each of the signal processing units 131, 132, and 133 newly detects a base station while the mobile station 100 is out of the coverage area of the corresponding wireless access network, the signal processing unit sends an interrupt signal to the CPU 101.

However, while the CPU 101 is in the suspend state, the signal processing performed by the OFDMA receiver unit 122 and the signal processing unit 133 for the wireless access network 230 (using WiMAX) can be stopped according to setting information which is inputted by the user. In this case, the operation for receiving the paging channel and the operation for searching for a base station are not performed. The signal processing may be stopped, for example, by stopping power supply to the circuitry realizing the above operations, or lowering the frequency of the clock signal supplied to the circuitry realizing the above operations. In addition, the transmission processing unit 160 and the wireless transmitter unit 170 may also be configured to intermittently operate while the mobile station 100 is in the standby state.

### 2.8 Functions of Control Unit in Mobile Station

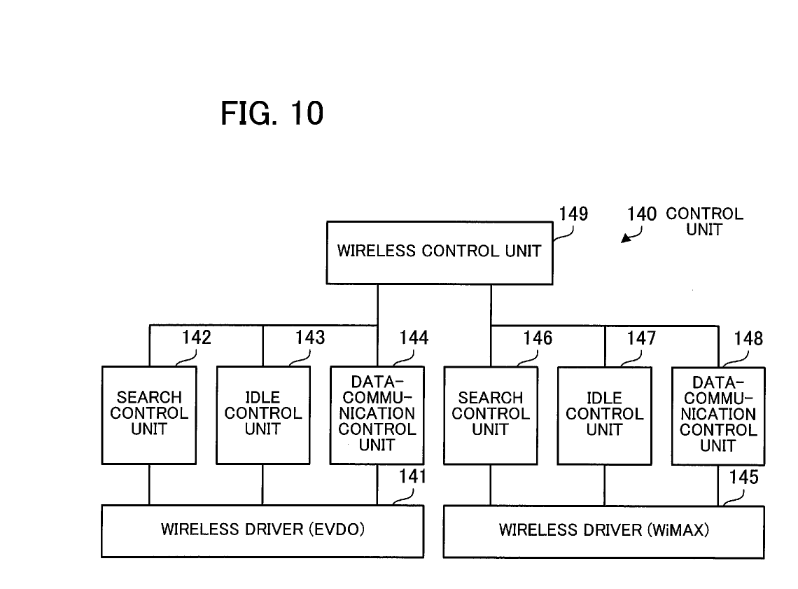

FIG. 10 illustrates functions of software executed by the control unit 140 in the mobile station 100 for controlling data communication using the wireless access networks 220 and 230. (The functions of software for controlling voice communication using the wireless access network 210 are not indicated in FIG. 10.) The control unit 140 contains wireless drivers 141 and 145, search control units 142 and 146, idle control units 143 and 147, data-communication control units 144 and 148, and a wireless control unit 149. The functions of the control unit 140 illustrated in FIG. 10 by the blocks can be realized by program modules executed by the CPU 101. The functions of the blocks illustrated in FIG. 10 are stopped while the CPU 101 is in the suspend state. When an interrupt signal is inputted into the CPU 101, the operation of the wireless control unit 149 is restarted, and the wireless control unit 149 calls the other functions of the control unit 140 illustrated in FIG. 10.

The wireless driver 141 controls signal processing performed by the signal processing unit 132 and the signal processing unit 162 for data communication in accordance with the CDMA2000 EVDO protocol, and the wireless driver 145 controls signal processing performed by the signal processing unit 133 and the signal processing unit 163 for data communication in accordance with the WiMAX protocol.

The search control unit 142 instructs the signal processing unit 132 through the wireless driver 141 to search for a base station in the wireless access network 220, and the search control unit 146 instructs the signal processing unit 133 through the wireless driver 145 to search for a base station in the wireless access network 230.

The idle control unit 143 detects a start and an end of data communication in accordance with the CDMA2000 EVDO protocol, and instructs the signal processing unit 132 and the signal processing unit 162 through the wireless driver 141 to switch between the active mode and the idle mode in CDMA2000 EVDO communication. The idle control unit 147 detects a start and an end of data communication in accordance with the WiMAX protocol, and instructs the signal processing unit 133 and the signal processing unit 163 through the wireless driver 145 to switch between the active mode and the idle mode in WiMAX communication.

The data-communication control unit 144 controls data communication in accordance with the CDMA2000 EVDO protocol, and the data-communication control unit 148 controls data communication in accordance with the WiMAX protocol.

The wireless control unit 149 exercises control over the PPP connection between the mobile station 100 and the wireless access network 220, the connection between the mobile station 100 and the wireless access network 230, handover between the wireless access networks 220 and 230, and the like. As explained later, in some cases, the wireless control unit 149 controls the handover from the wireless access network 220 (using CDMA2000 EVDO) to the wireless access network 230 (using WiMAX) in such a manner that IP continuity is ensured. In the handover having IP continuity, the IP address allocated to the mobile station 100 before the handover is inherited after the handover.

### 2.9 State Transitions for Data Communication

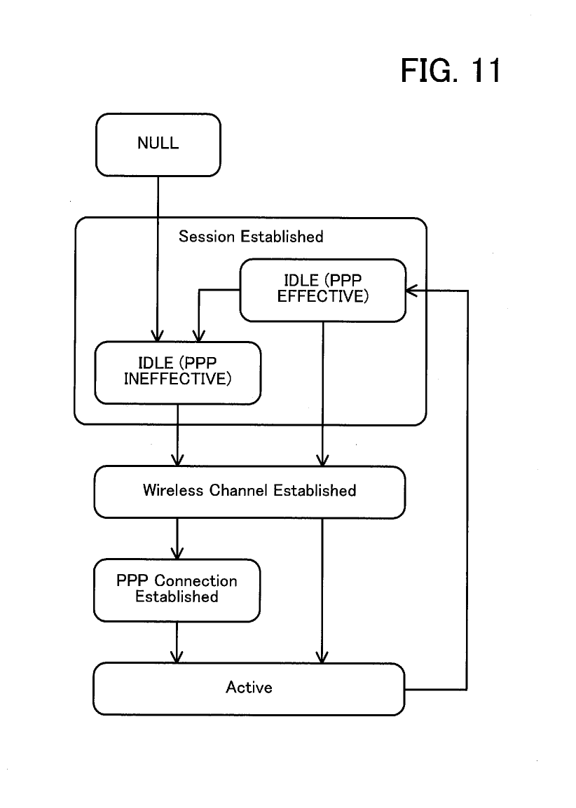

FIG. 11 illustrates examples of transitions between data communication states in data communication between the mobile station 100 and the wireless access network 220.

In the state “NULL”, the mobile station 100 stops signal processing for the wireless access network 220, and the mobile station 100 is powered off. When the mobile station 100 is powered on, the mobile station 100 wirelessly exchanges messages with the base station 211, so that the data communication state transitions from “NULL” to “IDLE (PPP INEFFECTIVE)”. That is, in the state “IDLE (PPP INEFFECTIVE)”, no PPP connection is established between the mobile station 100 and the wireless access network 220. When data communication is performed, the mobile station 100 establishes a traffic channel (TCH) as a wireless channel between the mobile station 100 and the base station 211, so that the data communication state transitions from “IDLE (PPP INEFFECTIVE)” to “WIRELESS CHANNEL ESTABLISHED”. When the mobile station 100 establishes a PPP connection to the PDSN 222 through the base station 211, the data communication state transitions from “WIRELESS CHANNEL ESTABLISHED” to “PPP CONNECTION ESTABLISHED”. That is, in the state “PPP CONNECTION ESTABLISHED”, a PPP connection is established by the mobile station 100 between the mobile station 100 and the wireless access network 220. When the mobile station 100 starts packet data communication through the PPP connection, the data communication state transitions from “PPP CONNECTION ESTABLISHED” to “ACTIVE”. That is, in the state “ACTIVE”, the mobile station 100 is performing data communication by using the wireless access network 220. When the data communication performed by the mobile station 100 is completed, the data communication state transitions from “ACTIVE” to “IDLE (PPP EFFECTIVE)”. That is, in state “IDLE (PPP EFFECTIVE)”, the PPP connection is maintained. When the mobile station 100 starts data communication in response to paging or occurrence of data to be transmitted, the mobile station 100 establishes the traffic channel again, so that the data communication state transitions from “IDLE (PPP EFFECTIVE)” to “WIRELESS CHANNEL ESTABLISHED”. However, since the PPP connection is already effective, the data communication state further transitions from “WIRELESS CHANNEL ESTABLISHED” to “ACTIVE” when the mobile station 100 starts the data communication through the PPP connection. On the other hand, when the mobile station 100 is connected to the wireless access network 230, the PPP connection to the wireless access network 220 becomes ineffective, so that the data communication state transitions from “IDLE (PPP EFFECTIVE)” to “IDLE (PPP INEFFECTIVE)”.

### 2.10 Screen for Selecting Off Setting

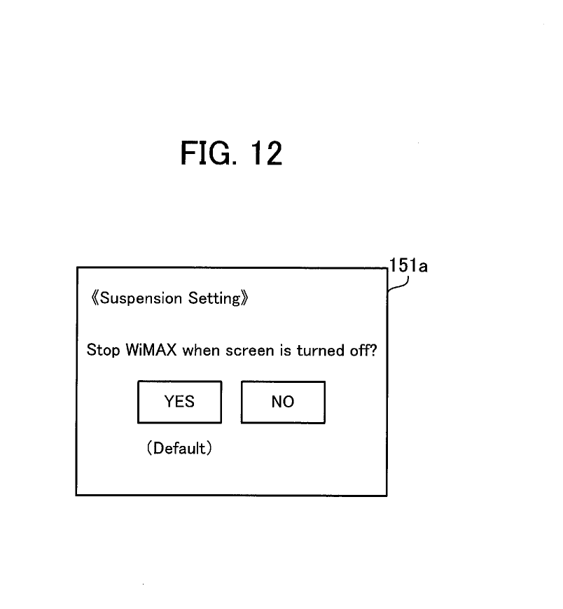

FIG. 12 illustrates an example of a screen for selecting off setting in the suspend state. The screen 151a of FIG. 12 is displayed on the display unit 151 by the control unit 140 in response to a manipulation by the user using the input unit 152. The screen 151a prompts the user to make a selection of “YES” or “NO” for determining whether or not the signal processing for the wireless access network 230 (using WiMAX) is to be stopped when the CPU 101 transitions to the suspend state and the screen of the display unit 151 is turned off (i.e., the backlight of the screen is turned off). In the example of FIG. 12, the default setting is “YES” (to stop the signal processing for the wireless access network 230). The control unit 140 acquires from the input unit 152 an input signal indicating the result of the above selection on the screen 151a, and writes in the storage unit 155 the result of the selection as a part of the setting information.

The screen 151a is one of screens which can be displayed for setting and is linked from a menu. The screen 151 a is displayed on the display unit 151 in response to a manipulation by the user while the CPU 101 is in the active state. However, the control unit 140 may control the display unit 151 to automatically display the screen 151a on the display unit 151 for prompting the user to make a selection for the setting immediately before the CPU 101 transitions to the suspend state.

### 2.11 Operations When CPU Transitions to Suspend State

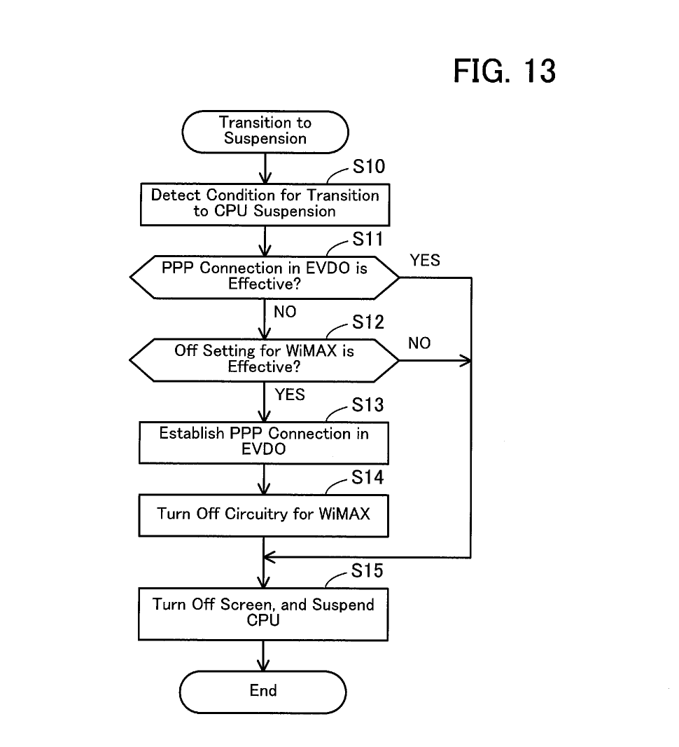

FIG. 13 illustrates an example of a flow of operations performed by the CPU when the CPU transitions to the suspend state.

<Step S10> The control unit 140 detects a condition in which the CPU 101 may transition from the active state to the suspend state. As explained before, the CPU 101 transitions to the suspend state when no event (for example, none of data communication, manipulation by the user, and the like) occurs during a certain period of time and none of the application programs and the driver programs is executed by the CPU 101 for the certain period of time.

<Step S11>p0 The control unit 140 determines whether or not the PPP connection to the wireless access network 220 is effective. When the PPP connection to the wireless access network 220 is effective, the operation goes to step S15. When the PPP connection to the wireless access network 220 is not effective, the operation goes to step S12. For example, the PPP connection to the wireless access network 220 is not effective in a WiMAX idle state (i.e., the state in which a connection to the wireless access network 230 is maintained after the mobile station 100 performs data communication using the wireless access network 230 in accordance with the WiMAX protocol).

<Step S12> The control unit 140 reads out the setting information stored in the storage unit 155, and determines whether or not the off setting (i.e., the setting for stopping WiMAX signal processing when the CPU 101 is in the suspend state) is effective. When the off setting is effective, the operation goes to step S13. When the off setting is not effective, the operation goes to step S15. In addition, when the off setting is not effective, the WiMAX idle state is maintained, and the signal processing unit 133 intermittently receives the paging channel for WiMAX communication.

<Step S13> The control unit 140 controls the signal processing unit 132 and the signal processing unit 162 to establish a PPP connection to the wireless access network 220 (using CDMA2000 EVDO), so that the state of the mobile station 100 with respect to the wireless access network 220 transitions from “IDLE (PPP INEFFECTIVE)” to “IDLE (PPP EFFECTIVE)”. In addition, the control unit 140 instructs the signal processing unit 132 to intermittently receive the paging channel while the mobile station 100 is in the EVDO idle state.

<Step S14> The control unit 140 controls the signal processing unit 133 and the signal processing unit 163 to stop signal processing (e.g., to inactivate the circuitry realizing the functions for WiMAX communication). For example, the control unit 140 stops the power supply to the signal processing unit 133 and the signal processing unit 163, or lowers the frequency of the clock signal supplied to the signal processing unit 133 and the signal processing unit 163. In addition, the control unit 140 may perform a procedure for cancelling the connection to the wireless access network 230 before inactivating the circuitry realizing the functions for WiMAX communication. Further, the operations in step S13 and S14 may be performed in parallel, or the operation in step S14 may precede the operation in step S13.

<Step S15> The control unit 140 turns off the backlight in the display unit 151 to turn off the screen, and then makes the CPU 101 transition from the active state to the suspend state. The CPU 101 may transition to the suspend state after the control unit 140 confirms completion of the operations in step S13 and S14, or after transmission of commands for the operations in step S13 and S14 to the reception processing unit 130 and the transmission processing unit 160 without confirmation of completion of the operations in step S13 and S14.

2.12 Operations When CPU is Released from Suspend State

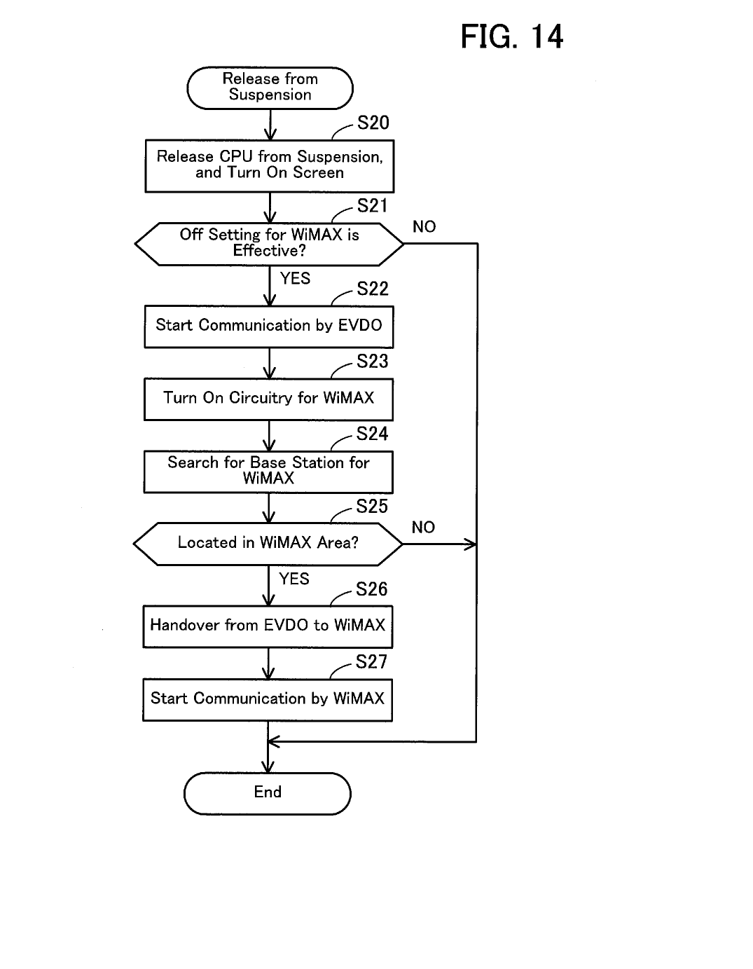

FIG. 14 illustrates an example of a flow of operations performed by the CPU 101 when the CPU 101 is released from the suspend state.

<Step S20> The control unit 140 detects that the CPU 101 returns from the suspend state to the active state in response to input of an interrupt signal. Then, the control unit 140 turns on the backlight in the display unit 151 to turn on the screen.

<Step S21> The control unit 140 reads out the setting information stored in the storage unit 155, and determines whether or not the off setting (i.e., the setting for stopping the WiMAX signal processing when the CPU 101 is in the suspend state) is effective. When the off setting is effective, the operation goes to step S22. When the off setting is not effective, the processing of FIG. 14 is completed. In addition, when the off setting is not effective, and the signal processing unit 133 continues the signal processing, the connection for the WiMAX communication is maintained.

<Step S22> Since the state of the mobile station 100 with respect to the wireless access network 220 is “IDLE (PPP EFFECTIVE)”, the control unit 140 controls the signal processing unit 132 and the signal processing unit 162 to establish a traffic channel between the mobile station 100 and the base station 211, and start data communication through the existing PPP connection.

<Step S23> The control unit 140 makes the signal processing unit 133 and the signal processing unit 163 restart the signal processing (e.g., activate the circuitry realizing the functions for WiMAX communication). For example, the control unit 140 restarts power supply to the signal processing unit 133 and the signal processing unit 163, or raising the frequency of the clock signal supplied to the signal processing unit 133 and the signal processing unit 163.

<Step S24> The control unit 140 controls the signal processing unit 133 to search for a base station in the wireless access network 230 (using WiMAX). Then, the signal processing unit 133 detects the preamble in the wireless frame, and searches for an accessible base station (e.g., a base station transmitting wireless signals which gives a reception power level or a reception quality level not falling below a certain threshold). Further, the operations in step S23 and S24 may be performed in parallel, or the operation in step S24 may precede the operation in step S23.

<Step S25> The control unit 140 determines, on the basis of the result of the search made in step S24, whether or not the mobile station 100 is in the coverage area of the wireless access network 230. When the mobile station 100 is determined to be in the coverage area of the wireless access network 230, the operation goes to step S26. When the mobile station 100 is determined to be out of the coverage area of the wireless access network 230, the processing of FIG. 14 is completed. Even when the mobile station 100 is determined to be out of the coverage area of the wireless access network 230, the signal processing unit 133 intermittently searches for a base station in order to detect that the mobile station 100 returns into the coverage area of the wireless access network 230. However, when the mobile station 100 is determined to be out of the coverage area of the wireless access network 230, the search for a base station may be stopped.

<Step S26> The control unit 140 controls the signal processing units 132, 133, 162, and 163 to perform handover from the wireless access network 220 (using EVDO) to the wireless access network 230 (using WiMAX) in such a manner that IP continuity is ensured. In the handover having IP continuity, the IP address allocated to the mobile station 100 before the handover is inherited after the handover. Therefore, it is possible to continue the service of data communication provided by the IP core network 320 to the mobile station 100 even when the handover is performed. Details of the procedure of the handover will be explained later.

<Step S27> The control unit 140 controls the signal processing unit 133 and the signal processing unit 163 to start data communication using the wireless access network 230. The PPP connection to the wireless access network 220 becomes ineffective when the handover to the wireless access network 230 is performed.

### 2.13 State Transitions Related to Suspension

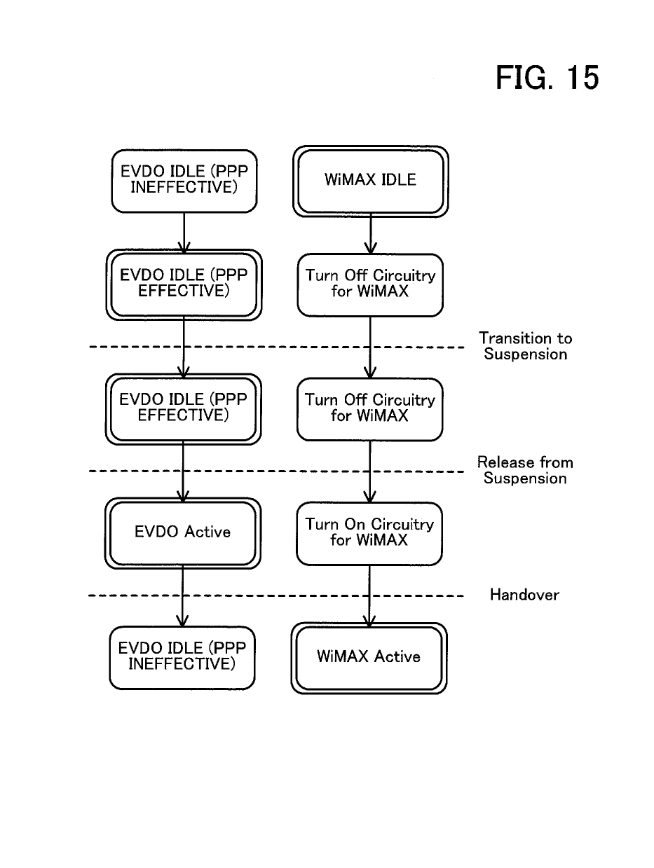

FIG. 15 illustrates examples of transitions between data communication states related to the suspension. In the example of FIG. 15, it is assumed that the setting for stopping the WiMAX signal processing is effective while the CPU 101 is in the suspend state.

After data communication which uses the wireless access network 230 (using WiMAX) is performed by the mobile station 100, the data communication path remains in the wireless access network 230, and the PPP connection to the wireless access network 220 (using EVDO) is ineffective. Therefore, the mobile station 100 intermittently receives the paging channel from the wireless access network 230 in the WiMAX idle state. At this time, the mobile station 100 does not receive the paging channel from the wireless access network 220 although the EVDO idle state is maintained.

Before the CPU 101 transitions to the suspend state because of the absence of data communication, the mobile station 100 establishes a PPP connection to the wireless access network 220. At this time, a data communication path is established in the wireless access network 220. Therefore, the mobile station 100 maintains the EVDO idle state, intermittently receives the paging channel from the wireless access network 220, and stops the WiMAX signal processing (e.g., inactivates the circuitry for WiMAX data communication). Thereafter, the CPU 101 in the mobile station 100 is controlled to transition to the suspend state.

While the CPU 101 is in the suspend state, the mobile station 100 maintains the EVDO idle state, and intermittently receives the paging channel from the wireless access network 220. In addition, the CPU 101 maintains the state in which the circuitry for WiMAX data communication is inactivated. When the CPU 101 is released from the suspend state, the mobile station 100 starts data communication using the wireless access network 220, so that the mobile station 100 transitions to the EVDO active state. In addition, the mobile station 100 restarts the WiMAX signal processing (e.g., activates the circuitry for WiMAX data communication), and confirms whether or not the mobile station 100 is in the coverage area of the wireless access network 230.

When it is confirmed that the mobile station 100 is in the coverage area of the wireless access network 230 after the CPU 101 is released from the suspend state, the mobile station 100 performs handover from the wireless access network 220 to the wireless access network 230 in such a manner that IP continuity is ensured. Thereafter, the mobile station 100 starts data communication using the wireless access network 230, and transitions to the WiMAX active state. Thus, a data communication path is established in the wireless access network 230, and the PPP connection in the wireless access network 220 becomes ineffective.

### 2.14 Operations for Establishing Connection

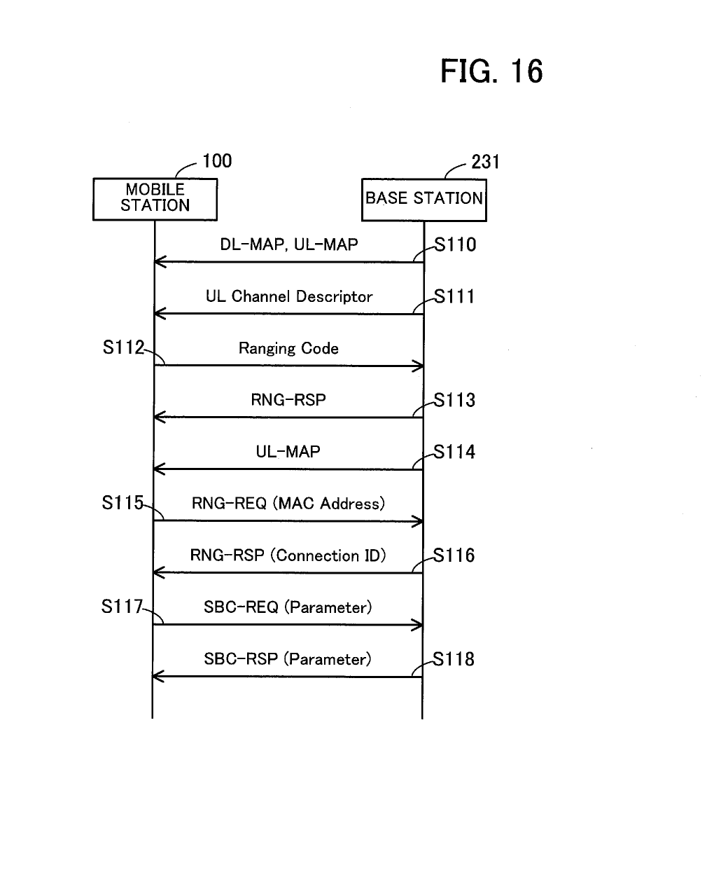

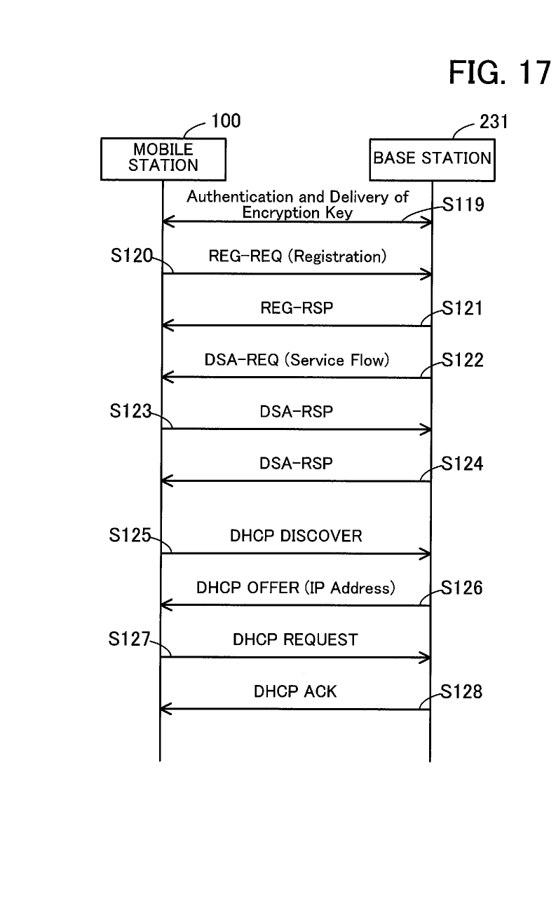

FIGS. 16 and 17 illustrate an example of a sequence of operations performed for establishing a connection to a wireless access network. In the example of FIGS. 16 and 17, the mobile station 100 is connected to the wireless access network 230.

In step S110, the base station 231 transmits the DL-MAP and the UL-MAP (which indicate allocations of wireless resources) through the DL subframe. The mobile station 100 receives the DL-MAP from the base station 231, confirms the position of the UL-MAP, and receives the UL-MAP.

In step S111, the base station 231 transmits through the DL bursts in the DL subframe a UL channel descriptor indicating the physical property of the UL subframe (e.g., a usable modulation and coding scheme). The mobile station 100 refers to the DL-MAP, and receives the UL channel descriptor.

In step S112, the mobile station 100 refers to the UL-MAP and the UL channel descriptor which are received from the base station 231, and determines the position of the ranging channel arranged in the UL subframe and a usable ranging code. Then, the mobile station 100 transmits the ranging code to the base station 231.

In step S113, when the base station 231 detects the ranging code, the base station 231 transmits a ranging response (RNG-RSP) message in the cell. At this time, the base station 231 does not yet recognize the source of the ranging code.

In step S114, the base station 231 allocates the wireless resource of one of the UL bursts to the source of the ranging code, and transmits the result of the allocation through the UL-MAP. In step S115 when the mobile station 100 receives the RNG-RSP message from the base station 231, the mobile station 100 refers to the UL-MAP, and confirms the wireless resource of the allocated UL burst by reference to the UL-MAP. Then, the mobile station 100 transmits a ranging request (RNG-REQ) message to the base station 231 by using the allocated wireless resource. The RNG-REQ message contains a MAC (Medium Access Control) address for identifying the mobile station 100.

In step S116, the base station 231 receives the RNG-REQ message, recognizes the mobile station 100, and assigns a connection ID for identifying a connection. Then, the base station 231 transmits to the mobile station 100 a RNG-RSP message which contains the connection ID. Thereafter, the mobile station 100 performs communication with the base station 231 by using the connection ID.

In step S117, in order to exchange information on the physical layer with the base station 231, the mobile station 100 transmits to the base station 231 an SBC-REQ message containing information indicating physical parameters in the mobile station 100 and a security method used in the mobile station 100. (SBC-REQ stands for Subscriber Station (SS) Basic Capability Request.) In step S118, the base station 231 transmits to the mobile station 100 an SBC-RSP message containing information indicating physical parameters in the base station 231 and a security method used in the base station 231. (SBC-RSP stands for Subscriber Station (SS) Basic Capability Response.)

In step S119, the mobile station 100 and the base station 231 perform authentication of the mobile station 100 by use of EAP (Extensible Authentication Protocol) and delivery of an encryption key for use in data communication to the mobile station 100. In step S120, the mobile station 100 transmits to the base station 231 a registration request (REG-REQ) message containing the communication capability of the mobile station 100. In step S121, the base station 231 determines the operation mode of wireless communication on the basis of the communication capability of the mobile station 100 and the communication capability of the base station 231, and transmits to the mobile station 100 a registration response (REG-RSP) message containing information indicating the operation mode.

In step S122, when the operation mode is determined by negotiation between the mobile station 100 and the base station 231, the base station 231 transmits a service request (DSA-REQ) message to the mobile station 100 in order to establish an initial service flow which can be used in allocation of an IP address, where DSA-REQ stands for Dynamic Service Addition Request. In step S123, the mobile station 100 confirms details of the service including the transaction ID and the QoS (Quality of Service) parameter, and transmits a service response (DSA-RSP) message to the base station 231, where DSA-RSP stands for Dynamic Service Addition Response. In step S124, the base station 231 establishes the initial service flow, and transmits a DSA-RSP message to the mobile station 100.

In step S125, when the initial service flow is established, the mobile station 100 transmits a DISCOVER message to the base station 231 by DHCP (Dynamic Host Configuration Protocol). In step S126, the base station 231 transmits to the mobile station 100 an OFFER message indicating a candidate for the IP address to be allocated to the mobile station 100. In step S127, when the mobile station 100 confirms that use of the transmitted candidate causes no problem, the mobile station 100 transmits a REQUEST message to the base station 231. In step S128, the base station 231 transmits to the mobile station 100 an ACK message indicating that the transmitted candidate is allocated to the mobile station 100.

### 2.15 Operations for Establishing Connections

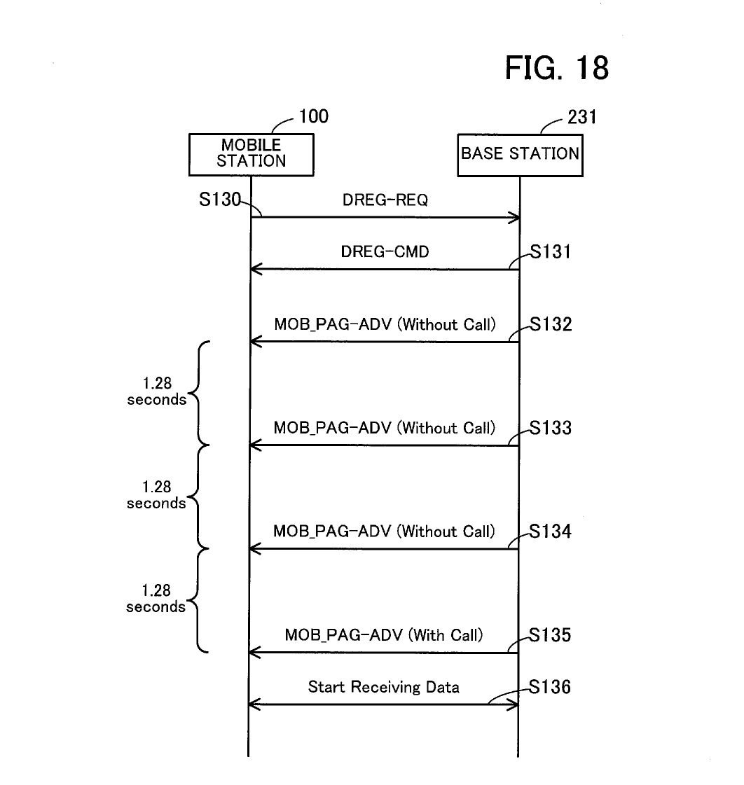

FIG. 18 illustrates an example of a sequence of operations performed for receiving a paging channel. In the example of FIG. 18, a data communication path is established in the wireless access network 230 (using WiMAX), and the mobile station 100 receives the paging channel from the wireless access network 230.

In step S130, when ten seconds elapse after completion of the data communication using the wireless access network 230, the mobile station 100 transitions to the WiMAX idle state. Therefore, the mobile station 100 transmits a deregistration request (DREG-REQ) message to the base station 231. In the DREG-REQ message, the action code is set to one. In step S131, when the base station 231 allows the mobile station 100 to transition to the WiMAX idle state, the base station 231 transmits a deregistration command (DREG-CMD) message to the mobile station 100. In the DREG-CMD message, the action code is set to five.

In steps S132, S133, and S134, the base station 231 periodically transmits a broadcasting mobile paging advertisement (MOG_PAG-ADV) message through the paging channel. The mobile station 100 receives the paging channel at a predetermined period (e.g., 1.28 seconds), and determines whether or not the mobile station 100 is called. When the mobile station 100 is not called, the mobile station 100 stops the signal processing for the wireless access network 230 until the time at which the mobile station 100 receives the paging channel next. When the mobile station 100 detects a call for the mobile station 100, the mobile station 100 is released from the WiMAX idle state in step S135, and starts reception of data from the wireless access network 230 in step S136.

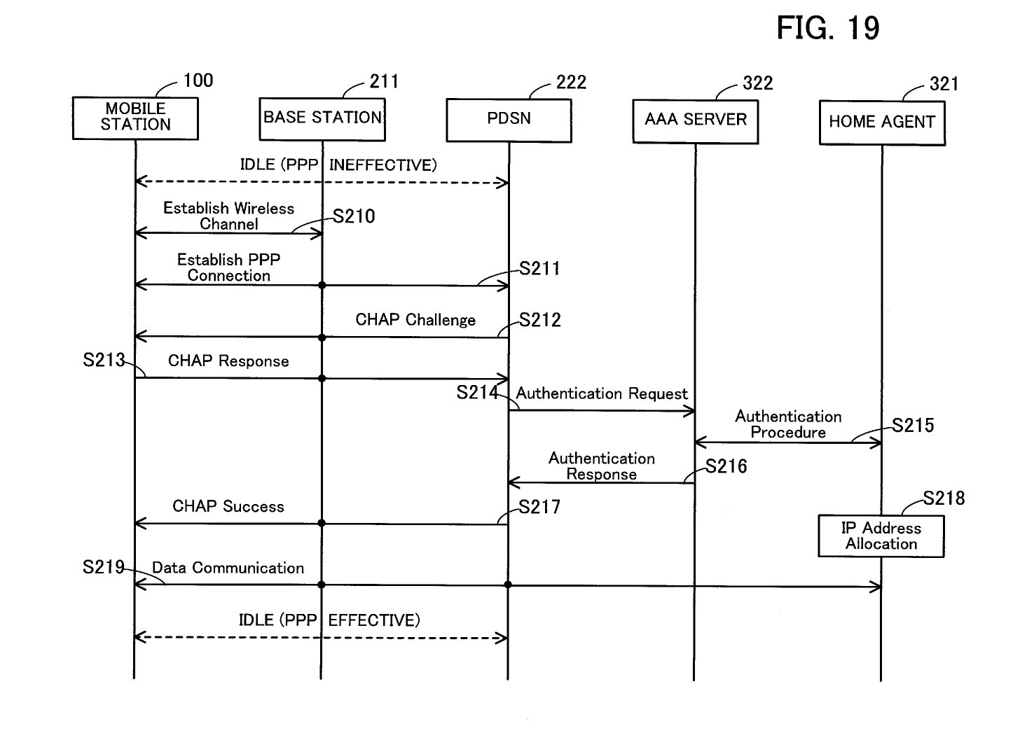

FIG. 19 illustrates an example of a sequence of operations performed for establishing a connection to another wireless access network. In the example of FIG. 19, the mobile station 100 is initially in the “IDLE (PPP INEFFECTIVE)” state. Then, the mobile station 100 establishes a PPP connection, performs data communication, and transitions to the “IDLE (PPP INEFFECTIVE)” state. The sequence of FIG. 19 is executed in step S13 in FIG. 13, which is explained before.

In step S210, the mobile station 100 performs communication with the base station 211, and establishes a wireless channel as a traffic channel. In step S211, the mobile station 100 accesses the base station 211 through the traffic channel, and establishes a PPP connection between the mobile station 100 and the PDSN 222 through the base station 211 and the PCF 221.

In step S212, in order to authenticate the mobile station 100, the PDSN 222 transmits to the mobile station 100 a CHAP challenge message containing a generated random number, where CHAP stands for Challenge Handshake Authentication Protocol. In step S213, the mobile station 100 applies a predetermined unidirectional function (e.g., a hash function) to the random number, and transmits to the PDSN 222 a CHAP response message containing the result of calculation of the predetermined unidirectional function by the mobile station 100. When the result of the calculation by the mobile station 100 is identical to an expected calculation result, which is calculated in the PDSN 222 by applying the predetermined unidirectional function to the random number, the mobile station 100 is authorized to establish a connection to the PDSN 222.

In step S214, the PDSN 222 requests the AAA server 322 to perform authentication of the mobile station 100. In step S215, the AAA server 322 exchanges with the HA 321 messages for the authentication, and registers the mobile station 100 in the HA 321. In step S216, the AAA server 322 transmits to the PDSN 222 a response message indicating success in the authentication. In step S217, the PDSN 222 transmits to the mobile station 100 a message indicating CHAP authentication. In step S218, the HA 321 allocates an IP address to the mobile station 100.

In step S219, when the mobile station 100 is authenticated and the IP address is allocated to the mobile station 100, data communication is performed. When the data communication is completed, the mobile station 100 transitions to the EVDO idle state. At this time, the PPP connection established between the mobile station 100 and the PDSN 222 is maintained.

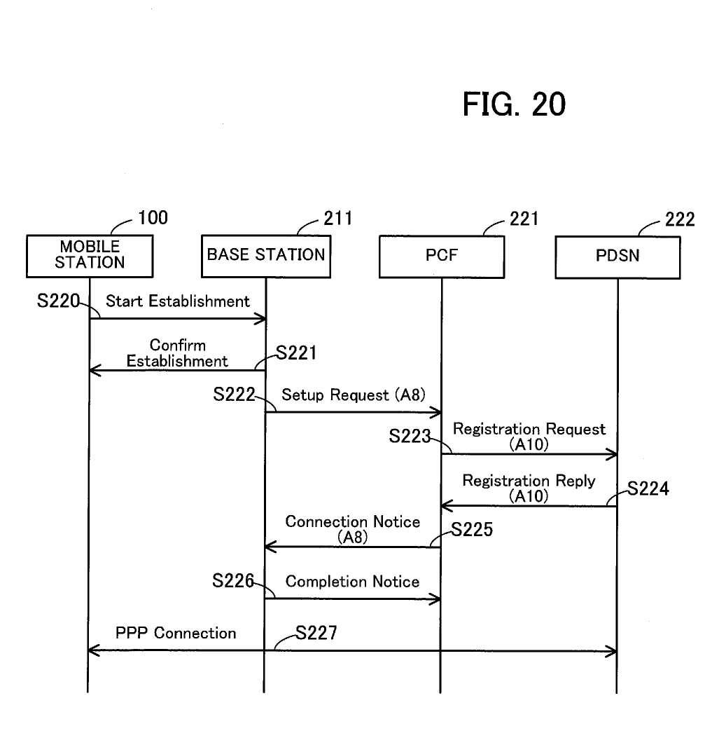

FIG. 20 illustrates details of an example of a sequence of operations performed for establishing the PPP connection in step S211. (Details of the Point-to-Point Protocol (PPP) is described in RFC (Request for Comments) 1661.)

In step S220, the mobile station 100 transmits through the traffic channel to the base station 211 a request to start establishing the PPP connection. In step S221, the base station 211 transmits to the mobile station 100 an acknowledgement reply acknowledging the start of the establishment. In step S222, the base station 211 establishes an A8 connection to the PCF 221, and transmits a setup request to the PCF 221 through the A8 connection. In step S223, the PCF 221 establishes an A10 connection to the PDSN 222, and transmits a registration request to the PDSN 222 through the A10 connection.

In step S224, the PDSN 222 transmits a registration reply to the PCF 221. In step S225, the PCF 221 transmits a connection notice to the base station 211. In step S226, the base station 211 transmits a completion notice to the PCF 221. In step S227, the mobile station 100 establishes a PPP connection between the mobile station 100 and the PDSN 222. Thus, the mobile station 100 becomes able to communicate with the PDSN 222 through the base station 211 and the PCF 221.

### 2.16 Operations for Receiving Another Paging Channel

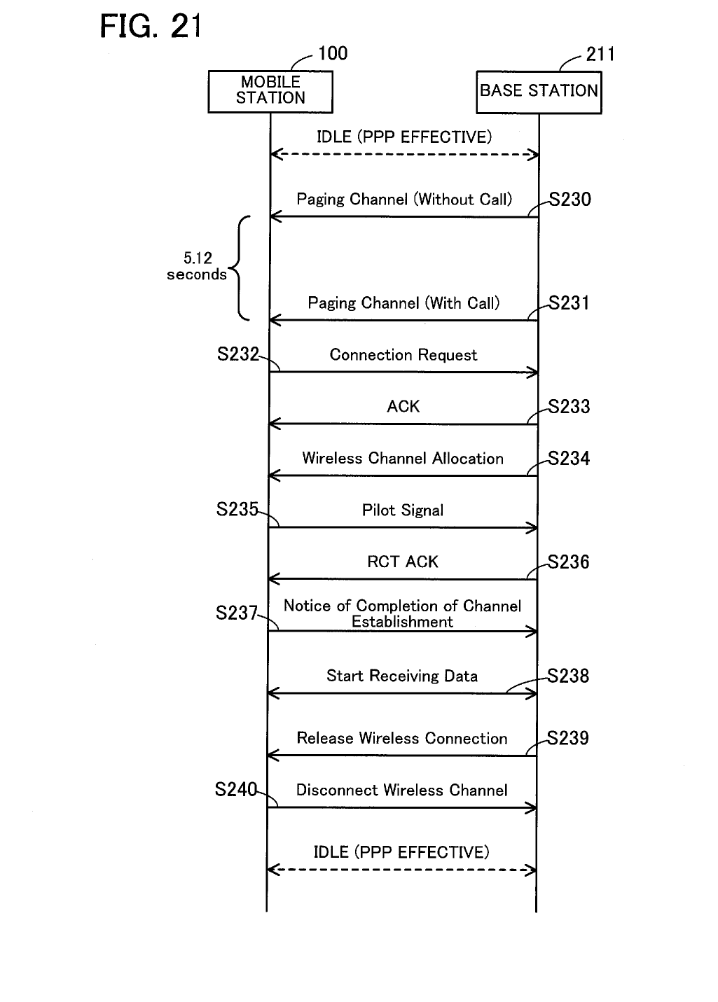

FIG. 21 illustrates an example of a sequence of operations performed for receiving another paging channel. In the example of FIG. 21, a data communication path is established in the wireless access network 220 (using CDMA2000 EVDO), and the mobile station 100 receives the paging channel from the wireless access network 220. The sequence of FIG. 21 is performed, for example, after step S15 in FIG. 13.

In step S230, the base station 211 periodically transmits the paging channel. The mobile station 100 receives the paging channel at a predetermined period of, for example, 5.12 seconds, and determines whether or not the mobile station 100 is called. When the mobile station 100 is not called, the mobile station 100 stops the signal processing for the wireless access network 220 until the time at which the mobile station 100 receives the paging channel next. When the mobile station 100 detects a call for the mobile station 100 in step S231, the mobile station 100 transmits a connection request to the base station 211 in step S232. In step S233, when the base station 211 detects the connection request from the mobile station 100, the base station 211 transmits an acknowledgement ACK to the mobile station 100.

In step S234, the base station 211 allocates a traffic channel to the mobile station 100, and informs the mobile station 100 of the channel allocation. In step S235, the mobile station 100 transmits a pilot signal through the traffic channel allocated by the base station 211. In step S236, when the base station 211 confirms, on the basis of the pilot signal received from the mobile station 100, that the communication quality of the allocated traffic channel is satisfactory, the base station 211 transmits to the mobile station 100 an acknowledgement ACK of the result of the radio conformance test (RCT). In step S237, the mobile station 100 informs the base station 211 of completion of the establishment of the traffic channel.

In step S238, the mobile station 100 starts data reception from the base station 211. At this time, the PPP connection is already established. Therefore, the mobile station 100 can quickly start data communication after the establishment of the wireless channel. In step S239, when data transmission to the mobile station 100 is completed, the base station 211 informs the mobile station 100 of release of the connection through the wireless channel. In step S240, the mobile station 100 releases the connection through the wireless channel, and transmits a response to the base station 211. However, the PPP connection is maintained. Thus, the mobile station 100 transitions again to the “IDLE (PPP EFFECTIVE)”.

### 2.17 Operations for Handover

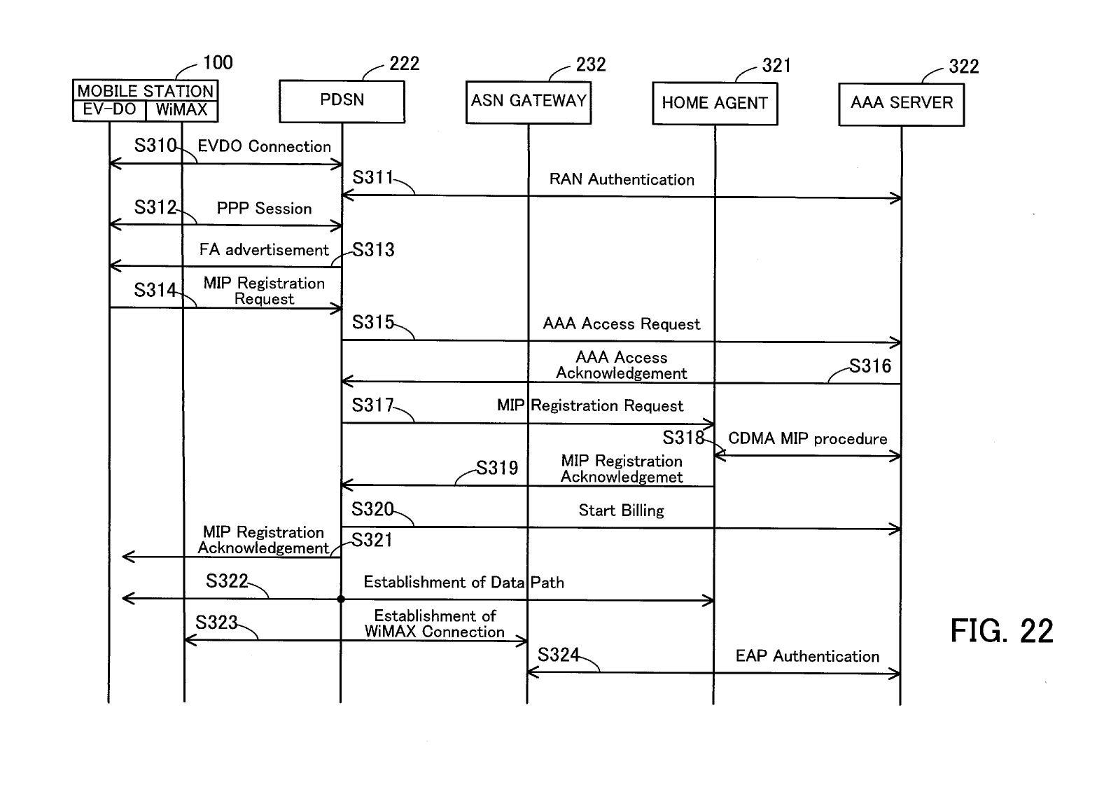

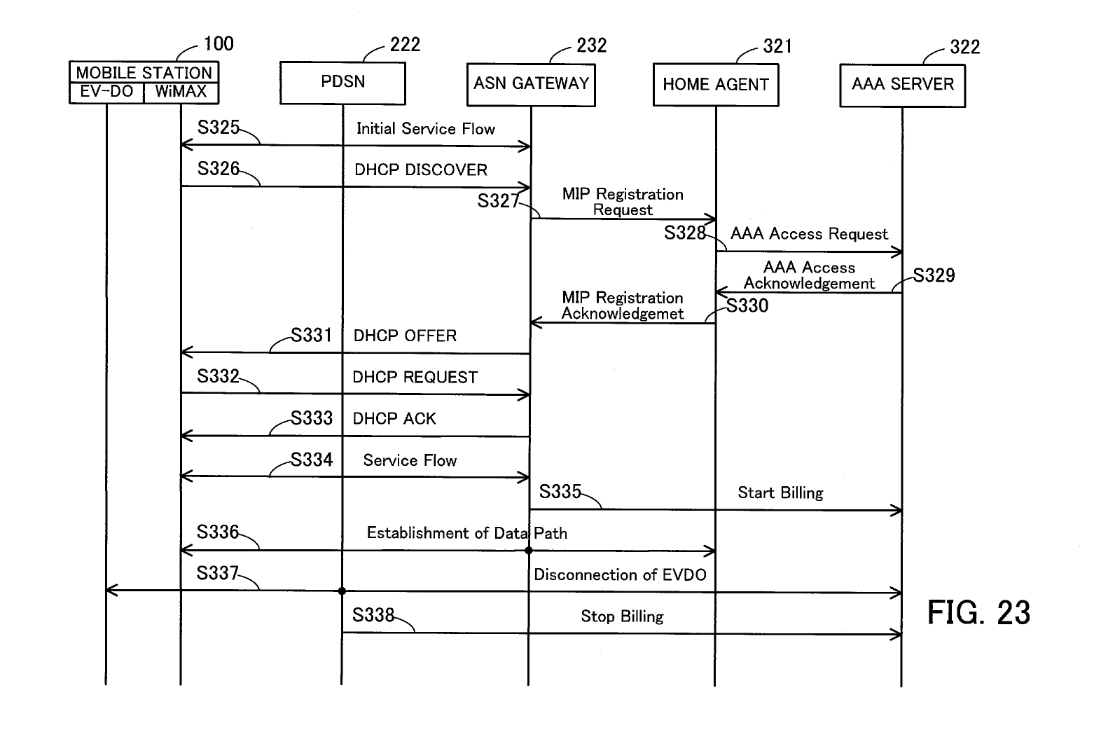

FIGS. 22 and 23 illustrate an example of a sequence of operations performed for handover. In the example of FIGS. 22 and 23, the mobile station 100 performs handover from the wireless access network 220 (using CDMA2000 EVDO) to the wireless access network 230 (using WiMAX) in such a manner that the allocation of the IP address is maintained (i.e., IP continuity is ensured). The sequence of FIGS. 22 and 23 is executed in step S26 in FIG. 14, which is explained before.

Further, another example of handover from an EVDO network to a WiMAX network is disclosed by Peretz Feder, Ramana Isukapalli, and Semyon Mizikovsky, “WiMAX-EVDO Internetworking Using Mobile IP, IEEE Communications Magazines, pp. 122-131, June 2009. (IEEE stands for The Institute of Electrical and Electronics Engineers.)

In step S310, the mobile station 100 establishes a wireless channel between the mobile station 100 and the base station 211, so that the mobile station 100 is connected to the PDSN 222 through the base station 211. In step S311, the PDSN 222 requests the AAA server 322 to authenticate the mobile station 100. Then, the AAA server 322 performs RAN authentication, where RAN stands for Radio Access Network. In step S312, the mobile station 100 sets up a PPP session between the mobile station 100 and the PDSN 222 through a PPP negotiation. In step S313, the PDSN 222 transmits to the mobile station 100 an FA advertisement as an MIP message, where FA stands for Foreign Agent, and MIP stands for Mobile Internet Protocol.

In step S314, the mobile station 100 transmits to the PDSN 222 an MIP registration request containing the IP address of the mobile station 100. In step S315, the PDSN 222 accesses the AAA server 322. In step S316, the AAA server 322 confirms that the mobile station 100 is already registered in the HA 321, and transmits to the PDSN 222 an access acknowledgement containing information indicating the HA 321.

In step S317, the PDSN 222 transmits an MIP registration request to the HA 321, of which the PDSN 222 is informed by the AAA server 322. The MIP registration request indicates that the mobile station 100 is in the CDMA2000 EVDO network. In step S318, the HA 321 confirms that the mobile station 100 is already registered, requests an encryption key from the AAA server 322, and makes the MIP registration request effective by using the encryption key acquired from the AAA server 322. In step S319, the HA 321 maintains the IP address which is already allocated to the mobile station 100, and transmits an MIP registration acknowledgment to the PDSN 222.

In step S320, the PDSN 222 transmits a notice to the AAA server 322 for causing the AAA server 322 to start billing the mobile station 100 for the use of the wireless access network 220. Then, in step S321, the PDSN 222 transmits the MIP registration acknowledgement to the mobile station 100. Thus, a data path is established between the mobile station 100 and the HA 321 through the PDSN 222 in step S322.

In step S323, the mobile station 100 establishes a connection to the wireless access network 230 (using WiMAX). In step S324, the ASN gateway 232 requests the AAA server 322 to authenticate the mobile station 100. Then, the AAA server 322 performs EAP authentication of the mobile station 100, where EAP stands for Extensible Authentication Protocol. In addition, the AAA server 322 designates the HA 321 as the home agent to handle the data communication with the mobile station 100.

In step S235, the ASN gateway 232 establishes an initial service flow between the mobile station 100 and the ASN gateway 232 through the base station 231. In step S326, the mobile station 100 transmits a DISCOVER message to the ASN gateway 232 in accordance with DHCP (Dynamic Host Configuration Protocol). In step S327, the ASN gateway 232 transmits an MIP registration request to the HA 321, of which the ASN gateway 232 is informed by the AAA server 322. The MIP registration request contains information indicating that the mobile station 100 exists in the WiMAX network.

In step S328, the HA 321 requests from the AAA server 322 an encryption key for making the MIP registration request effective. In step S329, the AAA server 322 transmits the encryption key to the HA 321. In step S330, the HA 321 makes the MIP registration request effective by using the encryption key received from the AAA server 322. In addition, the HA 321 maintains the IP address which is already allocated to the mobile station 100, and transmits an MIP registration acknowledgement to the ASN gateway 232.

In step S331, the ASN gateway 232 an OFFER message (in accordance with DHCP) to the mobile station 100 through the base station 231. In step S332, the mobile station 100 transmits a REQUEST message to the ASN gateway 232 through the base station 231. In step S333, the ASN gateway 232 transmits an ACK message to the mobile station 100 through the base station 231, where ACK stands for Acknowledgement. In step s334, the ASN gateway 232 establishes a service flow between the ASN gateway 232 and the mobile station 100 through the base station 231.

In step S335, the ASN gateway 232 transmits a notice to the AAA server 322 for causing the AAA server 322 to start billing the mobile station 100 for the use of the wireless access network 230. In step S336, a data path is established between the mobile station 100 and the HA 321 through the ASN gateway 232. In step S337, when the connection from the mobile station 100 to the wireless access network 230 succeeds, the PPP connection between the mobile station 100 and the wireless access network 220 becomes ineffective. Thus, the data communication path is changed. In step S338, the PDSN 222 transmits a notice to the AAA server 322 for causing the AAA server 322 to stop billing the mobile station 100 for the use of the wireless access network 230.

Although the MBBHO (Make-Before-Break Handover) is performed in the second embodiment, alternatively, BBMHO (Break-Before-Make Handover) may be performed. In the case of BBMHO, the mobile station 100 makes the connection to the wireless access network 230 effective after the connection to the wireless access network 220 is disconnected.

### 2.18 Advantages

The mobile communication system according to the second embodiment has the following advantages.

(1) According to the mobile communication system according to the second embodiment, when the CPU 101 transitions to the suspend state, the (WiMAX) signal processing for the wireless access network 230 performed in the mobile station 100 can be automatically stopped. Therefore, it is possible to avoid the increase in the power consumption caused by frequent out-of-service searches made in the wireless access network 230, which has a small coverage area. Thus, the provision in the second embodiment can reduce the energy consumption in the mobile station 100.

(2) When the signal processing for the wireless access network 230 is stopped, the data communication path can be automatically switched to the wireless access network 220 by establishing by the mobile station 100 a PPP connection between the mobile station 100 and the wireless access network 220 (using CDMA2000 EVDO). Therefore, the mobile station 100 can receive from the wireless access network 220 the paging information addressed to the mobile station 100.

(3) Since the mobile station 100 maintains the PPP connection after data communication is completed, it is unnecessary to perform operations for establishing a PPP connection after the mobile station 100 is called from the wireless access network 220. Therefore, it is possible to suppress the overhead processing before the start of the data communication.

(4) In the case where the mobile station 100 is in the coverage area of the wireless access network 230 when the suspend state is released, handover to the wireless access network 230 is automatically performed, so that the mobile station 100 is automatically connected to the wireless access network 230. Therefore, it is possible to preferentially use the wireless access network 230, which can perform communication at higher speed with a broader bandwidth.

(5) Since the handover realizing IP continuity is performed, the IP core network 320 can provide the data communication service to the mobile station 100 without intermission.

(6) Since the user can make a setting for determining whether to stop the signal processing for the wireless access network 230 when the mobile station 100 transitions to the suspend state, the user can choose power saving in or quick starting of data communication using the wireless access network 230.

### 3. Conclusion

According to the embodiments disclosed in this specification, it is possible to reduce power consumption in a mobile communication apparatus while the mobile communication apparatus is in a suspend state.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A mobile communication apparatus capable of performing data communication by use of a first wireless access network and a second wireless access network, the mobile communication apparatus comprising:
a receiver which processes signals received from the first wireless access network and the second wireless access network; and
a controller which includes a processor, and establishes a connection to the second wireless access network and stops processing of signals received from the first wireless access network when the processor transitions to a suspend state after data communication using the first wireless access network is performed.

2. The mobile communication apparatus according to claim 1, wherein when the processor is released from the suspend state, the controller restarts processing, performed by the receiver, of signals received from the first wireless access network, and performs handover from the second wireless access network to the first wireless access network.

3. The mobile communication apparatus according to claim 1, further comprising a memory which stores setting information indicating whether to continue processing of signals received from the first wireless access network while the processor is in the suspend state, wherein the controller determines establishment of the connection to the second wireless access network and stopping of the processing of signals received from the first wireless access network, by reference to the setting information.

4. The mobile communication apparatus according to claim 1, wherein the second wireless access network has a greater coverage area than the first wireless access network.

5. The mobile communication apparatus according to claim 1, wherein the connection to the second wireless access network is a PPP (Point-to-Point Protocol) connection.

6. A wireless communication method executed by a mobile communication apparatus which includes a processor and is capable of performing data communication by use of a first wireless access network and a second wireless access network, the wireless communication method comprising:
processing signals received from the first wireless access network and the second wireless access network; and
establishing a connection to the second wireless access network and stopping processing of signals received from the first wireless access network when the processor transitions to a suspend state after data communication using the first wireless access network is performed.
